(19) United States
(12) Patent Application Publication
(10) Pub. No.: US 2011/0147606 A1
(43) Pub. Date: Jun. 23, 2011

(54) Apparatus and method for the deflection of electromagnetic radiation, in particular of a laser beam

(75) Inventors: Thomas Bragagna, Feldkirch-Gisingen (AT); Simon Gross, Koblach (AT); Anton Gross, Koblach (AT); Max Erick Busse-Grawitz, Alpnach Dorf (CH); Dirk Fengels, Luzern (CH)

(73) Assignee: Pantec Biosolutions AG, Ruggell (LI)

(21) Appl. No.: 12/928,385

(22) Filed: Dec. 10, 2010

Related U.S. Application Data
(63) Continuation-in-part of application No. PCT/EP09/57253, filed on Jun. 11, 2009.

(30) Foreign Application Priority Data
Jun. 11, 2008 (EP) 08104381.2
Aug. 21, 2008 (EP) 08162718.4

(51) Int. Cl. H01J 3/14

(52) U.S. Cl. 250/396 R

(57) ABSTRACT

The deflection apparatus (1) for the deflection of electromagnetic radiation, in particular of a laser beam, includes a drive apparatus (2) and includes a beam deflection apparatus (4), in particular a mirror (4), which is arranged with the drive device (2) such that the drive apparatus (2) determines the alignment of the beam deflection apparatus (4), and includes a friction apparatus (5) which is arranged and made such that it brings about static friction or sliding friction onto the movably journaled beam deflection apparatus (4), with the drive apparatus (2) being made such that it can generate a drive force which overcomes the static friction, and includes a control apparatus (10) for the control of the drive apparatus (2). (FIG. 5)

### CROSS REFERENCE TO RELATED APPLICATIONS

Applicants claim priority on and this application is a continuation-in-part under 35 U.S.C. §120 of International Application No. PCT/EP2009/057253 filed Jun. 11, 2009, which claims priority under 35 U.S.C. §119 of European Application No. 08 104 381.2 filed on Jun. 11, 2008 and European Application No. 08 162 718.4 filed on Aug. 21, 2008. The International Application under PCT article 21(2) was not published in English. Applicants claim priority under 35 U.S.C. §119 of European Application No. 08 104 381.2 filed on Jun. 11, 2008 and European Application No. 08 162 718.4 filed on Aug. 21, 2008. The disclosures of the aforesaid International Application and European applications are incorporated by reference.

### BACKGROUND OF THE INVENTION

1. Description

The invention relates to an apparatus for the deflection of electromagnetic radiation, in particular of a laser beam, in accordance with the preamble of claim 1. The invention additionally relates to a method for the deflection of electromagnetic radiation, in particular of a laser scanner, in accordance with the preamble of claim 12.

2. Prior Art

Reference WO 2006/111526 discloses a laser apparatus including a pulsed laser as well as a deflection apparatus for the deflection of the laser beam. The pulsed laser as well as the deflection apparatus is mutually controlled such that the laser beam is deflected in defined directions, for example such that the laser beam impacts a surface at discrete points. Previously known deflection apparatus are admittedly fast, but are complex with respect to mechanics, electronics or sensor systems and are thus very expensive. In addition to that these systems are usually not energy efficient.

Reference U.S. Pat. No. 3,919,474 A discloses a system for transferring motion picture films to video recordings and for changing aspect ratio. This document discloses a deflection system that comprises a motor driven mirror which can be pivoted between cue positions, in particular nine discrete cue positions are disclosed. The motor is embodied as stepping motor which has a disadvantage that these types of motors tend to oscillate after completing the movement to the desired cue position. Therefore it is disclosed to add additional friction elements, in order to dampen the motor oscillations.

Representation Of The Invention

It is the object of the present invention to form a deflection apparatus for electromagnetic beams which can be operated fast and which can in particular also be manufactured cost-effectively. It is a further an objective of the present invention to form the deflection apparatus that provides a quick movement to the desired cue with reduced excess oscillation around the desired position and further a very high grade of reproducibility of the movement to the desired cue positions.

This object is satisfied using a deflection apparatus instrument having the features of claim 1. Dependent claims 2 to 10 relate to further, advantageously designed deflection apparatus. The object is in one embodiment solved using a deflection apparatus for the deflection of electromagnetic radiation, in particular of a laser beam, wherein the deflection apparatus includes a drive apparatus having a stator and a rotor, which is rotatably journaled with respect to the stator, as well as a beam deflection apparatus, in particular a mirror, which is connected to the rotor such that the angle of rotation of the rotor determines the alignment of the beam deflection apparatus. The deflection apparatus additionally includes a friction apparatus which is arranged and adapted such that it brings about static friction or sliding friction on the rotatably journaled rotor, wherein the drive apparatus is made such that it can generate a driving torque which overcomes the static friction, and wherein the deflection apparatus includes a control apparatus for the control of the drive apparatus. In another embodiment the deflection apparatus for the deflection of electromagnetic radiation, in particular of a laser beam, includes a drive apparatus as well as includes a beam deflection apparatus, in particular a mirror, which is arranged with the drive device such that the drive apparatus determines the alignment of the beam deflection apparatus, as well as includes a friction apparatus which is arranged and made such that it brings about static friction or sliding friction onto the movably journaled parts moved by the drive device, with the drive apparatus being made such that it can generate a drive force to move the movably journaled parts, as well as includes a control apparatus for the control of the drive apparatus.

The object is further satisfied using a method for the deflection of electromagnetic beams having the features of claim 11. Dependent claims 12 to 19 relate to further advantageous method steps. The object is in particular satisfied using a method for the deflection of electromagnetic radiation, in particular of a laser beam, having a rotatably journaled beam deflection apparatus, in particular a mirror, wherein the beam deflection apparatus is driven by a rotor of a drive apparatus, wherein static friction or sliding friction is brought about on the rotor, and wherein the drive apparatus is moved with the help of a starting pulse, and wherein the static friction and sliding friction, the amplitude of the starting pulses as well as the time period between two sequential starting pulses are mutually adapted such that the drive apparatus and the mirror become stationary between two sequential starting pulses. A starting pulse is understood as a control signal for the drive apparatus which has the result that the beam deflection apparatus is set into motion starting from standstill. It is further understood that the amplitude of the pulse incorporates also a magnitude of excitation, as a corresponding repulsion of the journaled parts of the motor can be achieved both when considering the amplitude or the magnitude of the electrical pulse.

Previously known deflection apparatus for the deflection of a laser beam usually use a mirror which is supported in a manner which is as friction-less as possible in order to operate the deflection of the mirror at high speed. Continuous power consumption is the drawback of such systems. In addition to that continuous power consumption heats the system which leads to problems in optical high precision systems e.g. misalignment because of thermal material expansion. In contrast to this, the deflection apparatus in accordance with the invention includes a friction apparatus which has the purpose of exerting static friction or sliding friction onto the moving parts of the deflection apparatus, in particular onto the rotatably journaled rotor or onto the beam deflection apparatus. The friction apparatus forming part of the deflection apparatus has the advantage that the drive apparatus can be operated with short pulses, with the pulses, for example a starting pulse, having such an amplitude and such a time period that, starting from a stationary drive apparatus, the static friction is overcome in a first phase so that the rotor moves and such that the moving rotor returns to a standstill again in a second phase due to the occurring sliding friction of the friction apparatus. Therefore only during the position change an electrical power input is required. As soon as the apparatus stops the positioning and also the position sensing system can be switched off and therefore have almost zero power consumption between the position changes which is important for battery powered devices. The above mentioned thermal problem is thus eliminated and the beam deflection systems are more stable and precise over time. In an advantageous embodiment, the friction apparatus brings about such static friction and sliding friction that the rotor moves in defined steps, or such that the rotor rotates around a reproducible, defined angle, until the rotor is stationary again. In addition to the static friction and sliding friction, the current pulse acting on the drive apparatus, in particular its amplitude, time period and/or time evolution, is preferably also selected such that the rotor rotates around a reproducible, defined angle. The deflection apparatus in accordance with the invention has the advantage that the beam deflection apparatus, advantageously designed as a mirror, can be moved very fast in steps in that the mirror is briefly moved and is then stationary during a short time period.

Furthermore the starting pulse can be specifically designed to have a repetition rate, a recess time or a pulse form, such that a defined number of starting pulses are required for the movement between the starting position and the end position. Furthermore a low rise time of the pulse can be selected to provide a strong initial torque in order to overcome the static friction and get the rotor in motion. It is further understood that the term pulse incorporated also an excitation, as motion of the journaled parts of the motor according to the present invention is initiated by an electrical pulse which results in an excitation of the magnetic field.

The deflection apparatus in accordance with the invention can be used particularly advantageously in combination with a pulsed laser in that a laser beam is respectively output with a stationary mirror so that the deflection of the mirror determines the direction of the deflected laser beam and the laser impacts a surface, for example, at a defined position.

The deflection apparatus in accordance with the invention has the advantage that it can be operated at high speed. As an example, the deflection apparatus may for example generate at least 500 starting pulses per second, which has the result that the mirror is rotated by an angle Δα 500 times a second and then becomes stationary again after every single starting pulse. If this deflection apparatus is combined with a pulsed or a continuously radiating laser, the laser can thus be deflected sequentially within one second, for example to 500 different positions of a surface. There is also the possibility during the standstill of the mirror of directing a single laser pulse or also a plurality of sequentially laser pulses to the mirror and to have them deflected in the same direction by it so that the same point is impacted a plurality of times by the laser beam. In an advantageous operating method, the starting pulses take place at regular time intervals. The time intervals between two starting pulses can, however, if necessary, also take place at irregular time intervals, for example if a closed loop is used, and the starting pulses are activated based on a measured actual value.

In an advantageous embodiment, the rotor is not only driven by a starting pulse, but also further pulses such as a stop pulse can additionally be used to brake the movements of the rotor in a defined manner.

In an advantageous embodiment, the deflection apparatus is operated as an open loop, also called feed-forward, in that the position of the mirror is not detected continuously, but only after a defined number of pulses, for example, or only when the mirror runs into a stop. The deflection apparatus in accordance with the invention has the advantage that the angle of rotation Δα of the rotor brought about by a starting pulse can be determined relatively accurately and is moreover relatively accurately reproducible so that the deflection apparatus can also be operated very accurately in an open loop or in open-loop operation or feed-forward operation in that the angle of rotation of the rotor or the angle of rotation of the mirror can be calculated relatively accurately based on the number of starting pulses exerted onto the deflection apparatus. The control can additionally take place fully digitally.

The deflection apparatus in accordance with the invention has the further advantage that it can be manufactured very cost-effectively. A motor available as standard is preferably used as the drive apparatus, with an additional friction apparatus being required to generate the required friction. The deflection apparatus in accordance with the invention has the further advantage that it can be designed to be very small and light. Since the current pulses exerted onto the drive apparatus are of a very short time period, the drive apparatus can be operated with current peaks whose amplitude amounts to at least tenfold or preferably also a hundredfold or more of the nominal current of the drive apparatus. This in turn produces the advantage that the drive apparatus can be designed to be relatively small despite the high current peaks. Such an overload of the drive apparatus is possible because a current pulse is of extremely short duration, preferably shorter than 1 ms. According to the present invention it is suitable to have a duration of the starting pulse of less than 5 ms.

It is further understood that the starting pulse can be embodies as a pulse train comprising several discrete pulses. This embodiment has the advantage that the parameters for each discrete pulse can be specifically adapted to generate a driving force or driving torque, in order to create a high acceleration for getting the drive apparatus to start moving away from the starting position. Then the pulse parameters are adapted to provide a smooth movement of the drive apparatus towards the desired end position, thus reducing vibrations or overshooting when entering the end position.

This description further applies to the stop pulse. When entering the stop position it is of importance to have the drive apparatus stop at the desired position with a reduced overshooting and/or reduced oscillation around the stop position. Therefore a controlled stopping of the movement without affecting the movement speed of the drive apparatus is of most importance. When reaching the vicinity of the stop position, first stop pulses can be applied to reduce the speed of the movement. Then when reaching the stop position, for stopping the drive apparatus, an intense stop pulse can be applied. It is further possible to generate several light start pulses after the intense stop pulse, in order for actively counteracting oscillations that might occur due to the intense stop pulse and inertia. These embodiments help to improve the accuracy of reaching a selected stop position out of a plurality of possible stop positions, especially with a high repetition accuracy, while maintaining a high operation speed. It is further possible to superimpose a static excitation of the drive apparatus with start and stop pulses, in order to reduce oscillations at the stop position while maintaining a high movement speed from the start to the stop position.

The invention will be explained in detail in the following with reference to embodiments.

### BRIEF DESCRIPTION OF THE DRAWINGS

The drawings used to illustrate the embodiments show:

FIG. 1 an embodiment of a deflection apparatus;

FIG. 2 a view of the deflection apparatus of FIG. 1 from direction A;

FIG. 3 a section through the deflection apparatus of FIG. 1 along the section line B-B;

FIG. 4 an embodiment for the deflection of a laser beam in the x and y directions;

FIG. 5 schematically, a laser apparatus including a laser, a deflection apparatus and further control apparatus;

FIG. 6 a step response of a mirror without a friction apparatus;

FIG. 7 an example of a control signal for the drive apparatus;

FIG. 8 a step response of a mirror with a friction apparatus and with a control signal consisting of a single pulse;

FIG. 9 a step response of a mirror with a friction apparatus and with the control signal shown in FIG. 7;

FIG. 10 a surface in which the points at which the laser beam impacts the surface are shown;

FIG. 11 rotational angle positions of the mirror between two stops;

FIG. 12a an embodiment of a deflection apparatus with a mirror movable in the x and y directions;

FIG. 12b a section along the section line C-C;

FIG. 12c a lower view of the deflection apparatus of FIG. 12a;

FIG. 13a a further embodiment of a deflection apparatus with a mirror movable in the x and y directions;

FIG. 13b a section along the section line D-D;

FIG. 13c a perspective view of the deflection apparatus of FIG. 13a;

FIG. 14a a further embodiment of a deflection apparatus with a mirror movable in the x and y directions;

FIG. 14b a lower view of the movable mirror;

FIG. 14c a plan view of the movable mirror;

FIG. 14d a section along the section line E-E;

FIG. 14e a section along the section line F-F;

FIG. 14f a side view from the right in accordance with FIG. 14c;

FIG. 15a a further embodiment of a deflection apparatus with a mirror movable in the x and y directions;

FIG. 15b a side view of FIG. 15a from below;

FIG. 15c a section along the section line G-G;

FIG. 15d a section along the section line H-H;

FIG. 15e a section along the section line I-I;

FIG. 16a a further embodiment of a deflection apparatus with a mirror movable in the x and y directions;

FIG. 16b a plan view of the movable mirror;

FIG. 16c a lower view of the movable mirror;

FIG. 16d a plan view of the deflection apparatus;

FIG. 16e a section along the section line K-K;

FIG. 16f a side view of FIG. 16d from below;

FIG. 16g a section along the section line L-L;

FIG. 16h a section along the section line M-M;

FIG. 17a a further embodiment of a deflection apparatus with a mirror movable in the x and y directions;

FIG. 17b a section along the section line N-N;

FIG. 17c a side view of the deflection apparatus in accordance with FIG. 17a;

FIG. 17d a perspective view of the deflection apparatus in accordance with FIG. 17a;

FIG. 18a a further embodiment of a deflection apparatus with a mirror movable in the x and y directions;

FIG. 18b a section along the section line O-O;

FIG. 18c a side view of the deflection apparatus in accordance with FIG. 18a;

FIG. 18d a section along the section line P-P;

FIG. 19a a further embodiment of a deflection apparatus with a mirror movable in the x and y directions;

FIG. 19b a section along the section line Q-Q;

FIG. 19c a lower view of the deflection apparatus in accordance with FIG. 19a;

FIG. 19d a detail of a friction device of the deflection apparatus in accordance with FIG. 19a;

FIG. 20a a further embodiment of a deflection apparatus with a mirror movable in the x and y directions;

FIG. 20b a section along the section line R-R;

FIG. 20c a side view of the deflection apparatus in accordance with FIG. 20a;

FIG. 20d a perspective lower view of the deflection apparatus in accordance with FIG. 20a;

FIG. 21a a further embodiment of a deflection apparatus with a mirror movable in the x and y directions;

FIG. 21b a section along the section line S-S;

FIG. 21c a side view of the deflection apparatus in accordance with FIG. 21a;

FIG. 21d a perspective lower view of the deflection apparatus in accordance with FIG. 21a;

FIG. 22a a further embodiment of a deflection apparatus with a mirror movable in the x and y directions;

FIG. 22b a section along the section line T-T;

FIG. 22c a side view of the deflection apparatus in accordance with FIG. 22a;

FIG. 22d a perspective lower view of the deflection apparatus in accordance with FIG. 22a;

FIG. 23a a further embodiment of a deflection apparatus with a mirror movable in the x and y directions;

FIG. 23b a section along the section line U-U;

FIG. 23c a side view of the deflection apparatus in accordance with FIG. 23a;

FIG. 23d a perspective lower view of the deflection apparatus in accordance with FIG. 23a;

FIG. 24a, 24b examples of apparatus for the detection of the position of the deflection apparatus;

FIG. 25 a further embodiment of a deflection apparatus with a mirror movable in the x and y directions and a linear drive;

FIG. 26a a further embodiment of a deflection apparatus with a mirror movable in the x and y directions;

FIG. 26b a side view of FIG. 26a from below;

FIG. 26c a side view of FIG. 26a from the left;

FIG. 26d a perspective view of FIG. 26a from below;

FIGS. 27a to 31c examples of apparatus for the detection of the position of the deflection apparatus;

FIGS. 32a to 32b a deflection of beams at the mirror;

FIGS. 33a a side view of a further embodiment of a drive apparatus including a friction apparatus;

FIG. 33b a top view of the drive device according to FIG. 33a;

FIG. 33c a top view of a deflection apparatus with a mirror movable in the x and y directions using a drive apparatus shown in FIGS. 33a and 33b;

FIG. 33d a side view of FIG. 33c;

FIG. 33e speed of the slider in function of the frequency applied;

FIG. 34a shows, inter alia, the movement of the slider versus time;

FIG. 34b shows, inter alia, a stop procedure to reduce the movement of the slider versus time.

Generally, the same parts are provided with the same reference numerals in the drawings.

### WAYS OF PERFORMING THE INVENTION

FIG. 1 shows an embodiment of a deflection apparatus 1 including a drive apparatus 2 made as a motor, wherein the motor includes a stator 2a and a rotor 2b rotatably journaled with respect to the stator 2a. A beam deflection apparatus 4, made as a rotatable mirror, is fixedly connected to the rotor 2b via the connection part 3. The connection part 3 includes a fastening section 3c for the mirror 4 and moreover includes a cylindrical section 3d having a groove 3a. A friction apparatus 5 is arranged between the drive apparatus 2 and the mirror 4 and exerts static friction or sliding friction onto the connection part 3. In the embodiment shown, the friction apparatus 5 includes two wires 5a, 5b which are held in a holding part 5c such that the two wires 5a, 5b have contact in the groove 3a of the connection part 3 on oppositely disposed sides. In the embodiment shown, the holding part 5c includes a slot-shaped bore 5e as well as a screw 5f. The force exerted onto the groove 3a by the two wires 5a, 5b, and thus also the static friction and sliding friction thereby caused, can be set via the screw 5f. The screw 5f is advantageously set such that the shaft 2b moves around a predetermined angle of rotation Δα when a preset current pulse is delivered to the motor 2.

The advantage over prior art lies in that the motor used within the drive apparatus provides a uninterrupted operation, whereas a stepping motor of prior art, provide only discrete angles of rotation to selected. Thus the drive apparatus of the present invention, which possible embodiments are described below, allows a quick movement from the starting angle to the, freely selectable, stopping angle. A motor of this type will start its motion, respectively its rotation, with the starting pulse and will continue this motion until a stopping pulse is provided—disregarded the all-time present friction. A stepping motor of prior art cannot conduct a steady motion (rotation), as only discrete motion steps are possible, which further depend on the mechanical characteristic of the motor. Therefore with a motor of prior art, a change in the cue position to be used for deflection purposes, require elaborate changes in the control logic of the stepping motor, even a change of the mechanical layout might be possible. With the embodiment of the present invention, the desired cue positions can be freely chosen, simply by adapting the timing of the start and stop pulses.

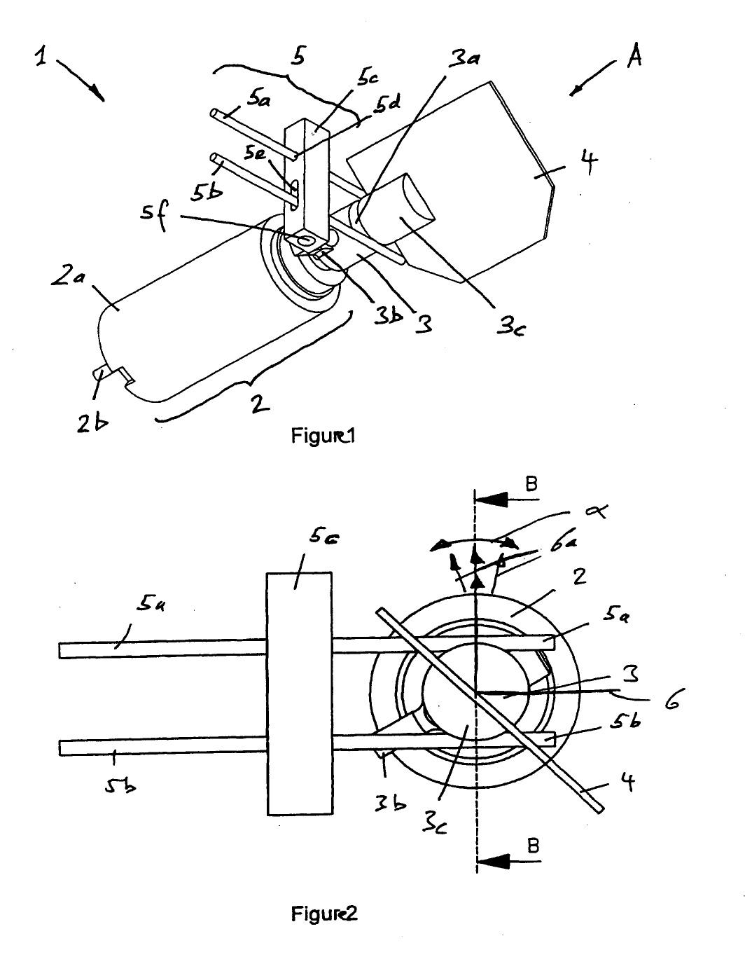

FIG. 2 shows the deflection device 1 shown in FIG. 1 from the direction of gaze A. The mirror 4 is rotatably connected to the drive apparatus 2 via the connection part 3. The holding part 5c and the wires 5a, 5b of the friction apparatus 5 can also be seen clearly, with the wires 5a, 5b contacting the connection part 3 under pretension in an oppositely disposed manner. The connection part 3 in the embodiment shown has a stop part 3b which can abut a stop not shown to preferably bring the connection part 3 into a defined starting position. A laser beam 6 is incident onto the mirror 4 and is deflected by it by an angle α, as shown schematically by the reflected laser beams 6a, 6b, 6c.

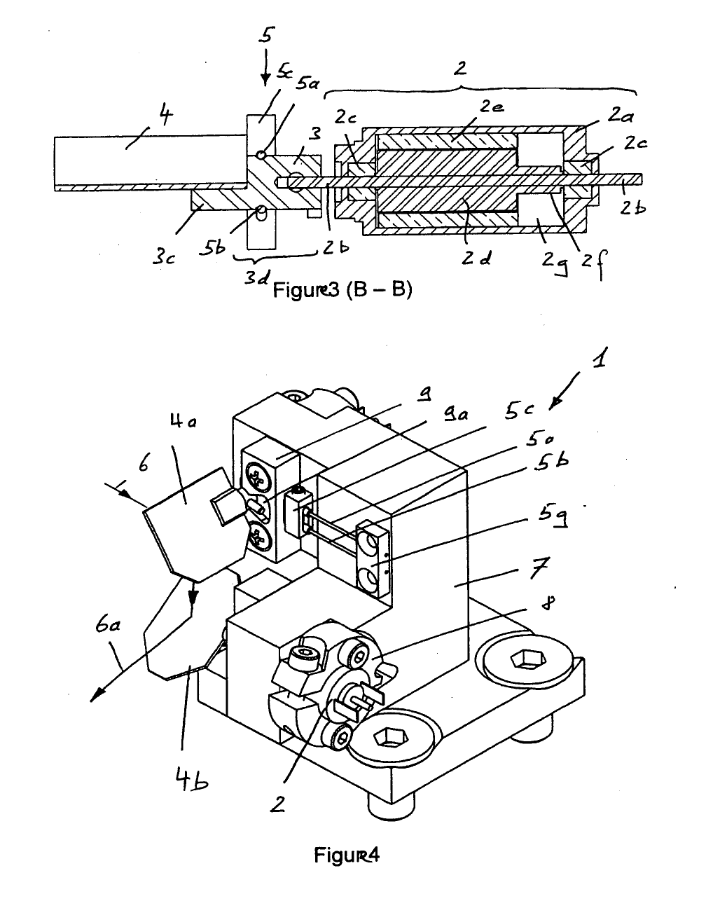

FIG. 3 shows a longitudinal section through the deflection apparatus 1 along the section line B-B shown in FIG. 2. The drive apparatus 2 made as an electric motor includes a stator 2a with a housing and a stator winding 2e and bearings 2c. The electric motor 2 additionally includes a rotor 2b with a shaft as well as a permanent magnet 2d. The electric motor 2 additionally includes a commutator 2f and graphite brushes 2g. The rotor 2b is connected to the mirror 4 via the connection part 3. The drive apparatus 2 can be made in a plurality of possibilities so that the embodiment shown is only to be seen as an example. The electric motor 2 could also have a stator 2a in the interior so that the rotor 2b surrounds the stator from the outside. The friction apparatus 5, which brings about static friction or sliding friction on the rotatably journaled parts, can also be made in a plurality of possibilities. The friction apparatus 5 could also be integrated in the drive apparatus 2 in that the friction apparatus 5 acts directly onto the rotor 2b. In the embodiment shown, the friction apparatus 5 brings about a direct mechanical contact onto the rotor 2b or onto the rotatably journaled parts. The friction apparatus 5 could, however, also act in a contactless manner, for example via inductive or capacitive forces.

FIG. 4 shows a further embodiment of a deflection apparatus 1 which has two of the arrangements shown in FIGS. 1 to 3 and thus has two rotatably journaled mirrors 4a, 4b, with each mirror 4a, 4b being driven by a motor 2. In the embodiment shown, the mirrors 4a, 4b are arranged movably with respect to the beam path of the laser 6 such that the deflected laser beam 6a is deflected in the x and y directions. A stop part 9 can additionally be seen from FIG. 4 which has a recess 9a in which the stop part 3b of the connection part 3 comes to lie. The maximum possible angle of rotation of the connection part 3, and thus also the maximum possible angle of rotation of the mirror 4, is limited by this arrangement.

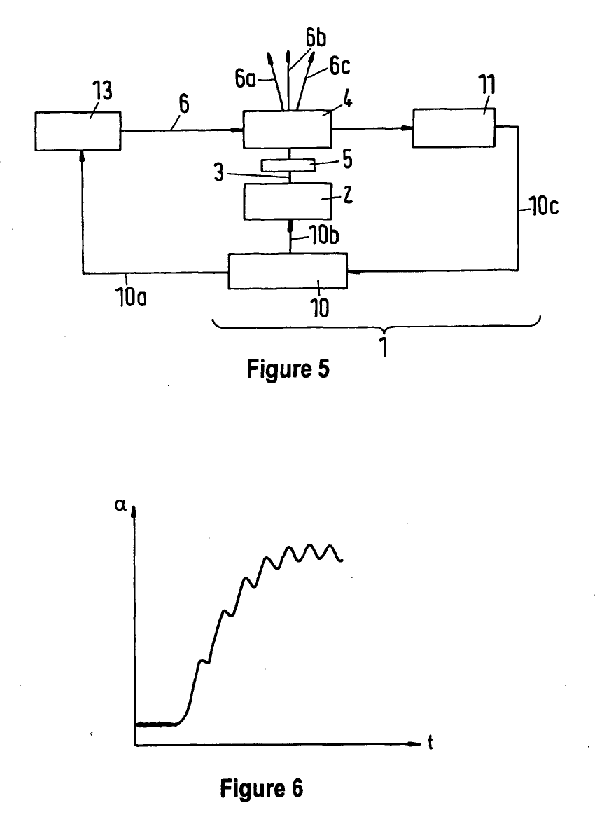

FIG. 5 schematically shows a deflection apparatus 1 including a drive apparatus 2 which is connected to a beam deflection apparatus 4 via a connection part 3. A friction apparatus 5 acts on the connection part 3. A control apparatus 10 is connected to the drive apparatus 2 via control lines 10b to control it and in particular to supply it with current pulses. A laser 13 which can be controlled by the control apparatus 10 via the control line 10a generates a laser beam 6 which is deflected by the mirror 4 as differently aligned laser beams 6a, 6b, 6c. The laser beam 6 is preferably pulsed, with the control apparatus 10 preferably controlling the laser 13 and the position of the mirror 4 such that a laser beam 6 is emitted when the mirror 4 is located in a position of rest. In the embodiment shown, a position sensor 11 is moreover provided which detects the position of the mirror 4 to forward the measured position to the control apparatus 10 via the control line 10c. This embodiment is also called a closed loop since the control apparatus 10 controls the position of the mirror 4 and detects its position so that a closed loop is formed.

The position sensor 11 could also be omitted so that the embodiment shown in FIG. 5 forms an open loop. As shown in FIG. 4 with the stop part 9 and the stop part 3b, the maximum angle of rotation of the mirror 4 could be limited by a stop apparatus. FIG. 11 shows the left hand and right hand stops 9b, 9c between which possible angle of rotation positions of the mirror 4 are shown as small dashes which are mutually spaced apart equally around an angle Δα in the embodiment shown. Under the proviso that it is possible to determine when the angle of rotation of the mirror 4 abuts the left hand or right hand stop 9b, 9c, the region lying in between can be controlled in a simple manner by the control apparatus 10 in an open-loop or in a feed-forward operation. The control apparatus 10 can, for example, supply the motor 2 with a constant current pulse, with each current pulse bringing about a rotation of the shaft 2b by an angle Δα. It is now possible to measure how many current pulses are required to move the mirror 4 or the shaft 2b from the stop 9b up to the stop 9c. It can thus be calculated from the angle Δα thereby traveled in total and from the number of required current pulses by which angle Δα the shaft 2b or the mirror 4 is moved by a single current pulse. With knowledge of this angle Δα, the control apparatus 10 can calculate the traveled angle of rotation of the shaft 2b or of the mirror 4 in dependence on the number of current pulses. If necessary, the angle Δα traveled per current pulse can also be modified in that the parameters of the current pulse, in particular its amplitude or its time period, are changed such that the angle Δα traveled per current pulse corresponds to a desired value. Which angle Δα a current pulse generates can thus be set via the control apparatus 10. Such a setting of the current pulse and of the angle Δα is possible both with an open-loop arrangement and with the closed-loop arrangement shown in FIG. 5. In FIG. 11, the total angle between the left hand and the right hand stops 9b, 9c could, for example, amount to 50°, with 50 or 500 steps being required, for example, to move the mirror 4 from the left hand to the right hand stop 9b, 9c.

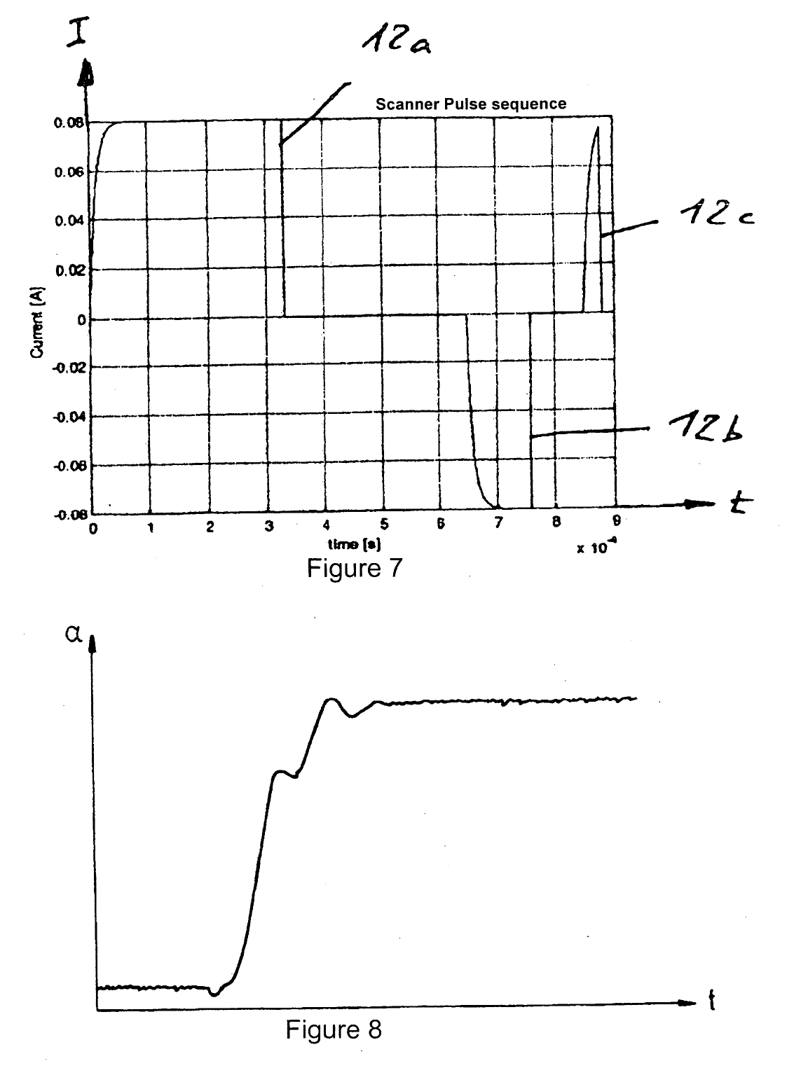

FIG. 7 shows a current over time diagram of the control of the motor 2 by way of example. First, a starting pulse 12a is output, a stop pulse 12b is output after a specific time and then a correction pulse 12c. The time evolution of the current pulses and also their amplitude can be selected from a plurality of possibilities to thereby specifically influence the movement of the shaft 2b.

In addition to the time evolution of the current supplied to the motor 2, in particular the effects of the friction apparatus must be taken into account. FIG. 6 shows the rotary movement of the shaft 2b or of the mirror 4 as a function of time. A single starting pulse 12a, shown in FIG. 7, is output to the motor 2 so that FIG. 6 shows the step response to the starting pulse 12a, with the deflection apparatus 1 used for FIG. 6 not having any friction apparatus 5. Due to the lack of a friction apparatus 5, the step response shown in FIG. 6 has a pronounced and long-lasting decay time, which means that the mirror is agitated and in particular vibrates. This behavior is not suitable to deflect the laser beam in a precisely defined direction.

Starting pulses 12a, stop pulses 12b or correction pulses 12c can naturally also have different pulse shapes than the ones shown in FIG. 7. It can, for example, prove to be advantageous to generate a starting pulse 12a with a very high amplitude in order to set the beam deflection apparatus 4 into motion or to release a beam deflection apparatus 4 blocked for some reason from the blockage in order then to move the beam deflection apparatus 4 with starting pulses of a lower amplitude; To move the beam deflection apparatus by a specific angular amount, a starting pulse with a high amplitude can be advantageous. In addition, the pulse can be designed as a function of time in a plurality of time evolutions, for example as a sawtooth pulse which has a very briefly rising flank and a slowly falling flank and is e.g. likewise suitable to generate a movement with a larger step length or a larger angular amount. The step length carried out after a starting pulse or the traveled angular amount of the beam deflection apparatus 4 or of the mirror 4 can thus be determined and, if necessary, also varied via the pulse shape, like the time evolution or the amplitude.

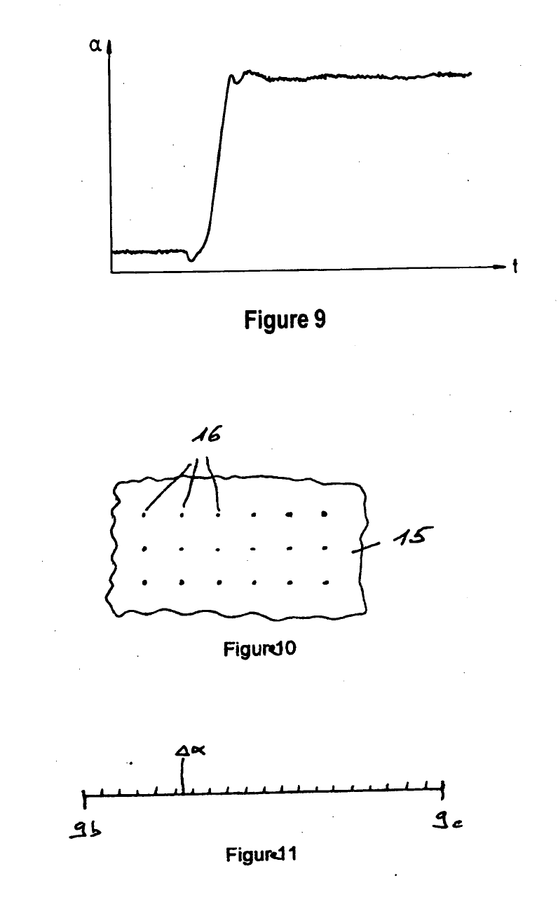

Unlike FIG. 6, the deflection apparatus 1 shown in FIG. 8 has a friction apparatus 5. The step response of the rotary movement of the shaft 2b or of the mirror 4 shown in FIG. 8 as a function of time to the starting pulse shown in FIG. 7 shows that the rotary movement becomes stationary again very fast. As soon as a standstill or at least an approximate standstill has been reached, the laser can be activated and the laser beam can be deflected in a defined direction by the position of the mirror 4. The current signal shown in FIG. 7 and the static friction and sliding friction brought about by the friction apparatus 5 can be set in a mutually matched manner such that the drive apparatus 2 has a desired step response, as the step responses shown in FIG. 8 or 9 show The step response shown in FIG. 9 is enhanced with respect to the step response shown in FIG. 8 in that the transition time between the starting position and the end position is shortened. In the present embodiment, this is achieved in that only the starting pulse 12a shown in FIG. 7 is used in the step response in accordance with FIG. 8, whereas the three pulses shown in FIG. 7, namely the starting pulse 12a, the stop pulse 12b and a correction pulse 13c, are used in the step response in accordance with FIG. 9. The amplitude, the time sequence and the time duration of these three pulses influence the evolution of the step response shown in FIG. 9. The correction pulse 12 can have a positive current value or also a negative current value depending on which time evolution the step response should adopt. It can also prove to be advantageous to apply more than one correction pulse 12c. The correction pulse or pulses 12c and possibly also the starting pulse 12a and/or the stop pulse 12b are selected in an advantageous method, in particular with respect to amplitude, time sequence and/or time duration, such that at least some of the natural vibrations or of the natural oscillations of the deflection apparatus 1, in particular of the beam deflection apparatus 4, are reduced or suppressed.

In an advantageous aspect, the deflection apparatus 1 is designed and the friction apparatus 5 is set and the current pulses are selected such that a starting pulse 12a of less than 1 ms is sufficient to move the shaft 2b or the mirror 4 by an angle Δα. In a further preferred embodiment, at least 500 starting and stop pulses 12a, 12b are generated per second with a standstill of the mirror 4 in between during which a laser beam 6 is directed to the mirror 4. The duration of the standstill preferably amounts to at least a third of the time duration lying between two sequential starting pulses 12a. In a preferred method, the pulse width of the starting pulses 12a, of the stop pulse 12b and/or of the correction pulse amounts to less than 500 μs.

In an advantageous method, the current peak of the starting pulse 12a, of the stop pulse 12b and/or of the correction pulse 12c amounts to at least tenfold, preferably at least a hundredfold of the nominal current of the drive apparatus 2. Since the duration of the pulses is extremely brief, such high nominal currents do not result in an overload of or damage to the drive apparatus 2. Such high nominal currents also enable large forces to be achieved with a small drive apparatus or enable a small and cost-effective drive apparatus to be used which is able to generate the required force.

The drive apparatus 2 in accordance with the invention is used particularly advantageously in combination with a pulsed laser 13. FIG. 10 shows a plan view of a skin surface 15 which has a plurality of discrete pores 16 generated using the laser 13. These pores 16 should preferably be generated at regular intervals and preferably also as fast as possible. The drive apparatus 2 in accordance with the invention with two movable mirrors 4 as shown in FIG. 4 in combination with a pulsed laser 13 allows the pores 16 shown in FIG. 10 to be generated very fast. The drive apparatus 2 in accordance with the invention, for example, allows 500 different deflection angles to be generated per second, with it moreover being possible to supply a plurality of laser beams to the same pore 16 sequentially during the standstill of the mirror 4. Thanks to the drive apparatus in accordance with the invention, approximately 500 pores 16 can thus, for example, be generated per second. An application time of fractions of seconds up to a few seconds is thus required to generate a plurality of pores 16 at the skin surface, for example.

The starting pulses 12a can take place at regular time intervals. It is, however, also possible to supply the starting pulses 12a to the motor 2 at irregular intervals, for example because the mirror 4 should be stationary during differently long times because, for example, the laser beam 13 is activated during a longer time depending on the deflection or the mirror 4 or because a plurality of sequential laser pulses should be deflected in the same direction.

The beam deflection apparatus 4 can be made in different manners, for example as a mirror, but, for example, also as a prism or as a crystal.

The drive apparatus 2 can be made in a plurality of possibilities, for example as a linear actuator such as a voice coil actuator, similar to an audio loudspeaker, or as a stroke magnet, or as a piezo actuator or a piezo stack actuator or piezo sawtooth actuator (piezo stepper), or as a linear motor on the basis of a linear multi-magnet arrangement, with the N and S poles always being arranged next to one another and a coil pair being moved over them in a linear fashion. The magnetic band can also partially be arranged in parallel above and beneath the coil pairs. Further linear actuators could be:
linear steppers (stepper motor which transfers the rotary movement to a shaft so that a linear movement results)
principle of the crankshaft and connecting rod
principle of converting a rotary movement into a linear movement via an eccentric device and a lever.

The drive apparatus 2 can also be made as a rotary actuator such as:
voice coil, rotary, (known from computer hard disks)
motors in the general sense (brushless and with brushes)
galvanometers (moving coil and moving magnet)
stepper motors
bimetal actuator
bending piezo actuator
any principle that is supported via a pivot joint and is actuated either via electrostatics or via magnetic force or electromagnetically and thus results in a rotary movement

Friction forces, in particular static friction or sliding friction can be generated with a plurality of apparatus, e.g.:
in ball bearings
in sliding bearings
sliding bearings, additionally adjustably clampable
eddy current brakes
principle of a friction clutch such as is known with automobiles
a body which presses with a spring or other, possibly adjustable, supply force (also actively, e.g. by means of piezo) onto another body
causes friction in the drivetrain (cf. eccentric lever)

Restoring forces can be generated, for example, by means of springs, torsion or actively by means of an actuator.

A plurality of regulation methods and regulation mechanisms are possible for the operation of the deflection apparatus, such as:
In a closed-loop system with intentionally generated friction (friction apparatus), the mirror 4 can be stepped or moved through in steps from one mechanical end stop to the other end stop, the number of steps can be counted, then it can be stepped back, the steps compared and the step sizes can be changed as required to determine and optionally compensate effects such as ageing, environmental conditions, changing linearity, etc.
In a closed-loop system with feedback (sensor) and intentional generated friction (friction apparatus), if the static friction cannot be overcome as expected, the starting pulse can be extended or increased temporarily and then reset back to the usual value.
The back EMF can naturally also be measured at the motor to recognize whether the mirror is stationary or, if it is moving, feeds back the same values as with the other pulses.
The power consumption can also be measured at the motor, for example for the detection of a blockage.
It applies with piezo systems that a preset voltage at the piezo results in a defined, reproducible positional change. This is similar with bimetal actuators.

The position, in particular the deflection, of the mirror 4 can be measured using a plurality of sensors, in particular using angle sensors or sensor systems—angle or position detectors. The rotation can, for example, be measured by:

rotary encoders which are, for example, installed at rotatable axes. Possible detection methods and sensors are, for example:
magnetoresistive
inductive
optical rotary encoders
capacitive (known from galvanometers)
proximity sensors
strain gages

Linear movements can, for example, be measured using linear encoders, as usual with scales in linear axes and other linear motors. Possible detection methods and sensors for linear measurements are, for example:
magnetoresistive
inductive
optical linear encoders
laser triangulation
Laser TOF (time of flight) measurements (distance measuring instruments)
capacitive (known from galvanometers)
proximity sensors

Two or three dimensional movements can, for example, be measured using light or laser beams hitting two dimensional CCD chips, as usual as for example used in a personal computer mouse. Other optical sensors can for example detect a surface and if the surface is moved the optical sensor respectively its controller compares the sensor signal of the first position with the signal of the second position and can then determine the position change. Another method of two or three dimensional measurement is a magnetoresistive sensor such as the Melexis MLX90333. With such a device one can measure X-, Y- and Z-axis positions at once.

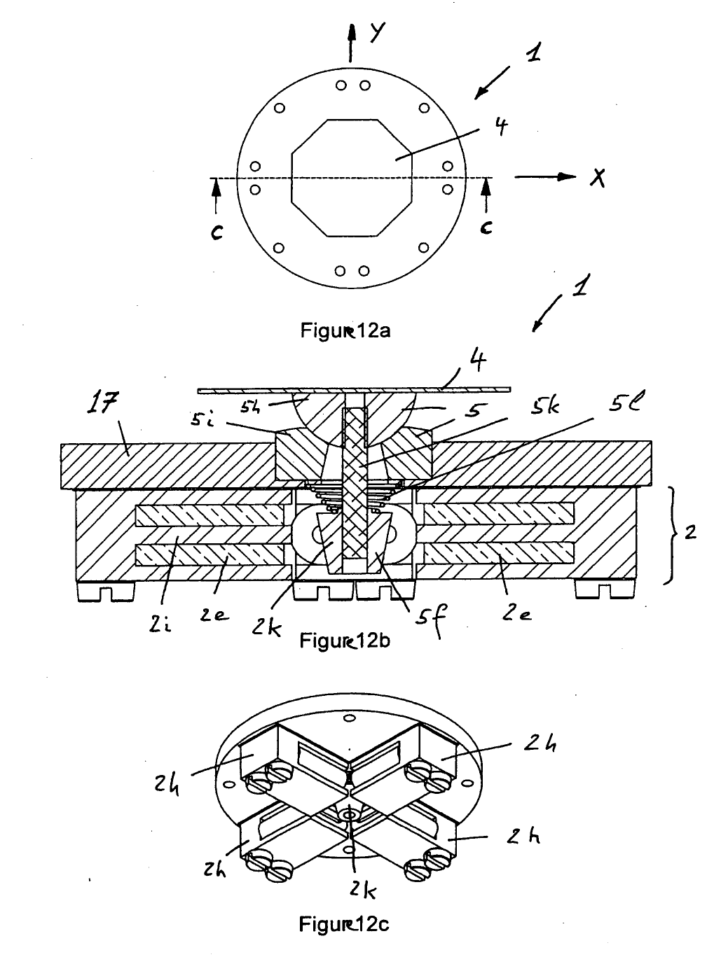

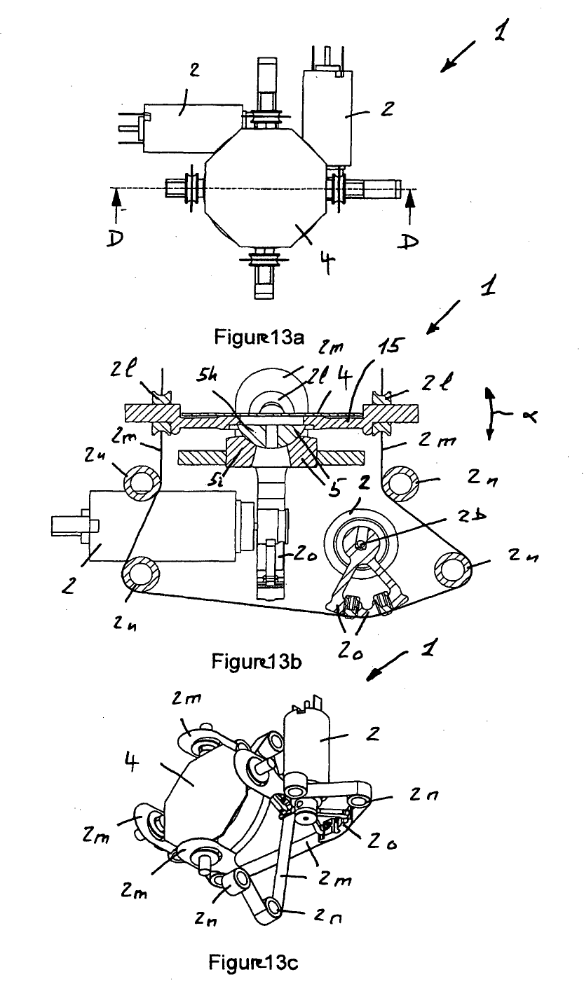

FIGS. 12a to 12c show a further embodiment of a deflection apparatus 1 having a mirror 4 pivotably journaled in two dimensions. FIG. 12b shows a longitudinal section along the section line C-C. The mirror 4 is pivotably connected via the friction apparatus 5 to the base part 17 arranged beneath it. The friction apparatus 5 includes a semi-spherical part 5h as well as a sliding and holding part 5i made with mirror symmetry and with a semi-spherical recess. The friction apparatus 5 additionally includes a connection time 5k, a spring 5l as well as a clamping device 5f with which the pressing force of the spring 5l between the clamping device 5f and the holding part 5i can be set The contact force between the part 5h and the part 5i can be set via the pressing force so that the holding force and friction force of the friction apparatus 5 can be set. As can also be seen from FIG. 12c, four magnets 2h are arranged extending in a cruciform manner beneath the base part 17, with an armature 2k being located at the center which additionally forms the clamping device 5f in the embodiment shown. Each magnet 2h includes a magnetic core 2i as well as a magnetic coil 2e. Two oppositely disposed magnets 2h each together form a drive apparatus 2 so that the first drive apparatus 2 brings about a deflection of the mirror 4 and thus of the laser beam reflected at the mirror 4 in the X direction and the second drive apparatus 2 brings about a deflection of the mirror 4 or of the laser beam in the Y direction.

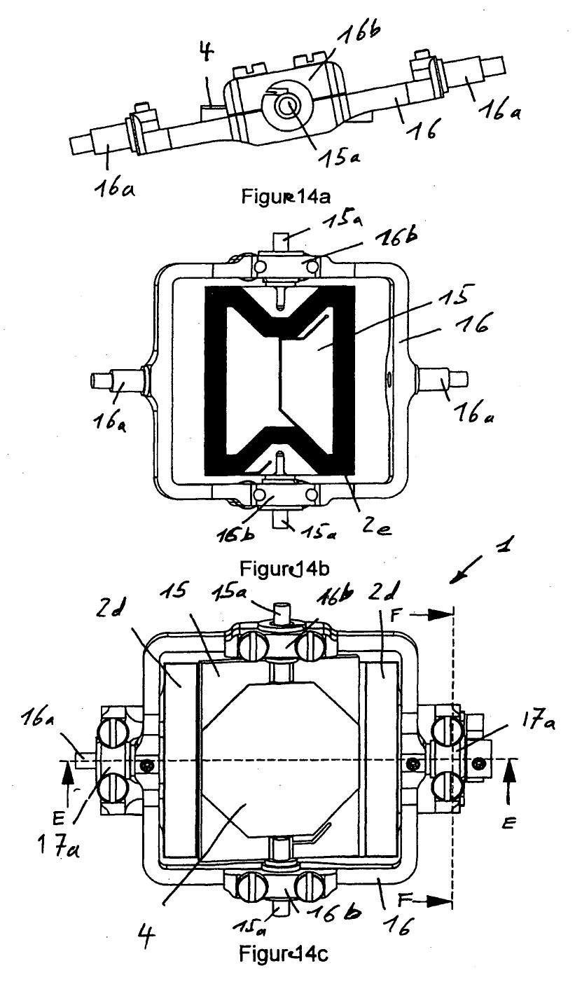

The deflection apparatus 1 shown in FIGS. 12a to 12c can, as described in FIGS. 7 to 11, be controlled in that the drive apparatus 2 is operated with the starting current pulse 12a shown in FIG. 7 such that the static friction of the friction apparatus 5 is overcome and the mirror 4 or the semi-spherical part 5h is thus moved briefly with respect to the part 5i. The existing sliding friction has the effect that the mirror 4 moves back to a position of rest very fast after a starting pulse 12a has taken place. The two drive apparatus 2 can be provided sequentially in time or also simultaneously with a current pulse to bring about a rotational movement of the mirror 4 in the X or Y direction or in the X and Y directions. FIG. 4 shows an embodiment of a deflection apparatus 1 having two mirrors 4a, 4b which are each rotatably journaled in one direction. In contrast to this, the embodiment shown in FIGS. 12a to 12c discloses a single mirror 4 which is instead displaceably journaled with respect to two dimensions. Otherwise, the deflection apparatus 1 shown in FIGS. 4 and 12a to 12c can be operated in a very similar fashion per se. FIGS. 13a to 13c show a further embodiment of a deflection apparatus 1 with a mirror 4, with this deflection apparatus 1 being driven by two motors 2, as are shown, for example, in FIGS. 1 to 3. FIG. 13b shows a section along the section line D-D. The friction apparatus 5 has a similar design as shown in FIG. 12b, with a semi-spherical part 5h as well as a counter-part 5i with a semi-spherical recess, so that the mirror 4 is movably journaled with respect to two dimensions, with the static friction and sliding friction of the friction apparatus 5 in particular also being determined by the design of the contact surfaces and by the contact forces of the parts 5h, 5i. It can be seen from FIG. 13b that the pivot part 15 on which the mirror 4 lies is connected to the drive apparatus 2 via fastening parts 2l, a common flexible band 2m as well as via deflection rolls 2n, with the band 2m being fixedly connected to the shaft 2b of the drive apparatus via an arm 2o. The drive apparatus 2 can be made as an electric motor, as is shown in FIGS. 1 to 3. An actuation of the drive apparatus 2 has the result that the pivot part 15 moves in the direction of the angle Δα. As can in particular be seen from FIG. 13c, the deflection apparatus 1 includes two flexible bands 2m, with each band 2m being driven by a drive apparatus 2 so that the pivot part 15, and thus the mirror 4, is displaceably journaled with respect to two dimensions.

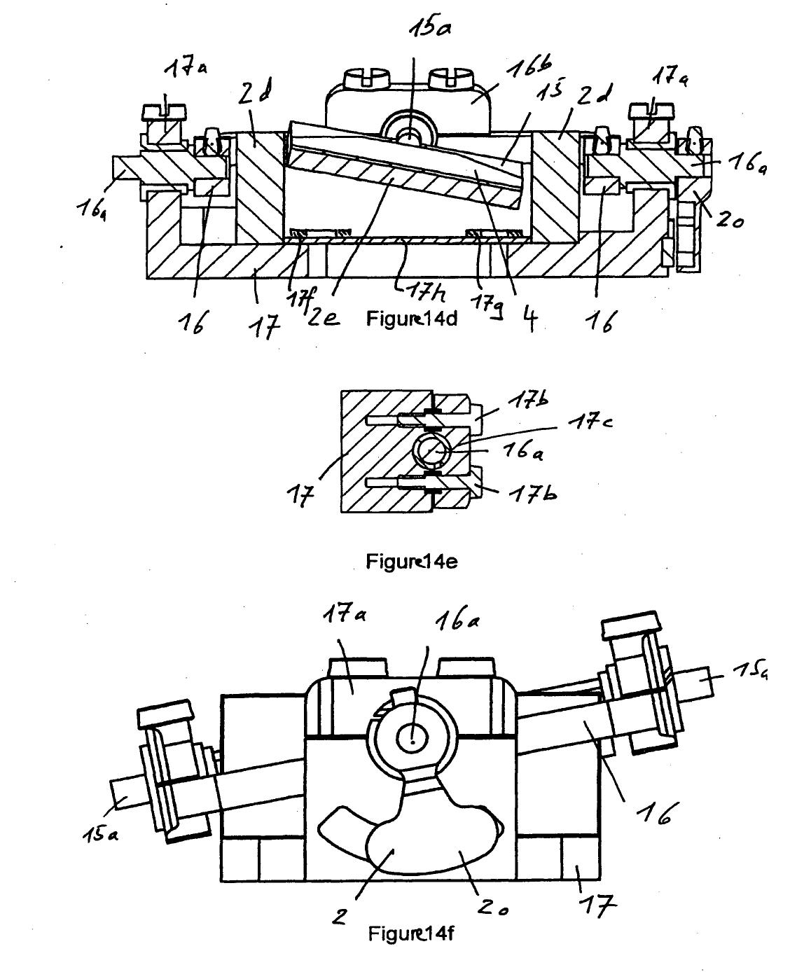

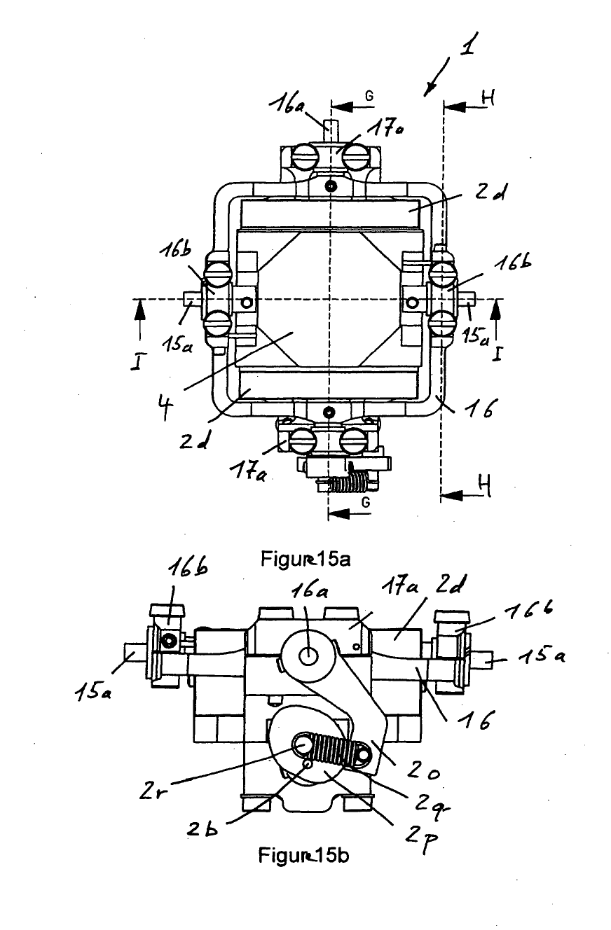

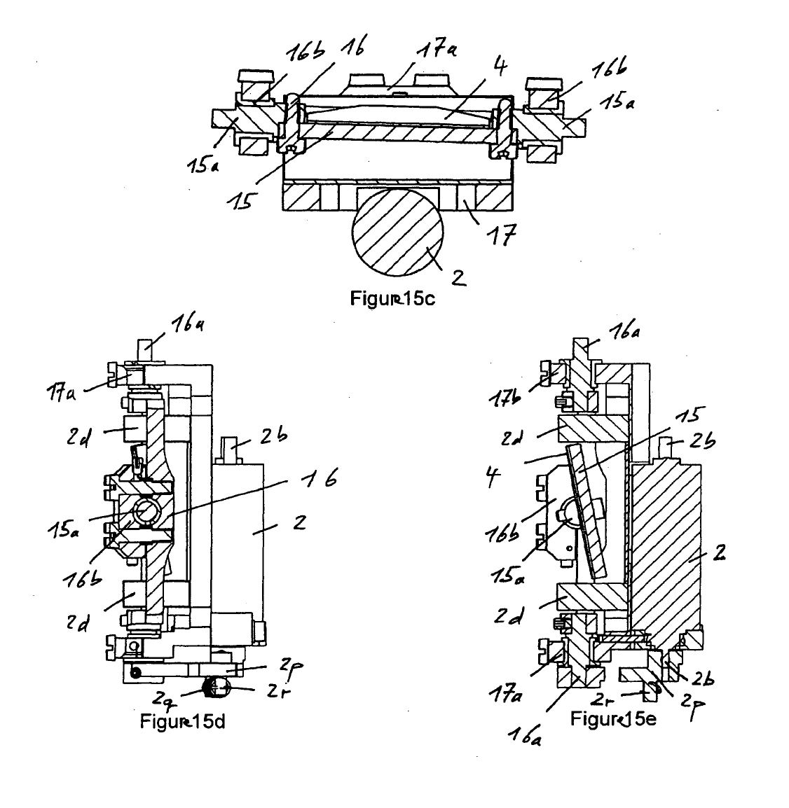

FIGS. 14a to 14f show a further embodiment of a deflection apparatus 1. The deflection apparatus 1 shown in FIG. 14c includes a pivot part 15 having axles 15a, with the pivot part 15 being rotatably journaled in bearings 16b. The mirror 4 is fastened to the pivot part 15. The deflection apparatus 1 additionally includes a frame 16 having axles 16a which are rotatably journaled in a bearing 17a. The axle 15a and the bearing 16b or the axle 16a and the bearing 17a respectively form one friction apparatus 5, with the pressing force, and thus also the static friction and the sliding friction, being adjustable via the screws of the bearing 16b or 17a respectively. Two permanent magnets 2d are moreover fastened to the frame 16. FIG. 14a shows a side view of the frame 16 with an axle 15a rotatably journaled in the bearing 16b, with the pivot part 15 with the mirror 4 being arranged slightly rotated with respect to the frame 16. FIG. 14b shows the frame 16 shown in FIG. 14a from below. The pivot part 15 includes two electrically conductive turns respectively coils 2e. These turns 2e together with the two permanent magnets 2d form a drive apparatus 2 so that the pivot part 15 can be pivoted around the axle 15a in dependence on the current flowing through the turns 2e. In an advantageous embodiment, the axle 15a as well as the bearing 16b are made as a friction apparatus 5 to bring about static friction and sliding friction. In a further advantageous embodiment, the axle 15a is journaled in the bearing 16b with low friction or with no friction where possible so that the pivot part 15 can be operated similar to a galvanometer in that the turns 2e continuously have current passed through them and the deflection of the pivot part 15 with respect to the permanent magnets 2d is thereby determined. In addition, a restoring device, not shown, could be provided to move the pivot part 15 automatically into a defined zero position. The restoring device is advantageously made as a spring, preferably such that the pivot part 15 extends in the view shown in FIG. 14a parallel to the frame 16 in the position of rest.

FIG. 14d shows a section along the section line E-E. The bearings 17a form part of a base part 17. At the right, the axle 16a is connected to an arm 2o of a drive apparatus 2. FIG. 14e shows a section along the section line F-F. A fastening part 17c is connected to the base part 17 via screws 17b. In a preferred aspect, the fastening part 17c, the base part 17 and the axle 16a form a friction apparatus 5, with the forces being settable via the screws 17b. In a further advantageous aspect, the axle 16a is journaled with as low a friction as possible with respect to the base part 17. In a further advantageous embodiment the coil 2e can additionally be used for position sensing. Such an embodiment comprises one or two additional coils 17f, 17g, for example arranged spaced apart on a printed circuit board 17h, as shown in FIG. 14d. To determine the position of the pivot part 15 a current is fed to coil 2e or to one of the two coils 17f, 17g, whereby the current strength is selected such that the current is not sufficient to change the position of the pivot part 15, but induces a voltage in the respective counter coil 2e, 17f or 17g, whereby this induced voltage can be measured. The amount of measured induction is preferably directly proportional to the distance/angle of the coil 2e to the coil 17f, 17g, which allows determining the position of the coil 2e as well as the position of the pivot part 15 connected with the coil 2e.

FIG. 14f shows a view of the right hand end face of the deflection apparatus 1 shown in FIG. 14c. The arm 2o, which carries the coil pair of a rotary voice coil motor in this example and which runs over a magnetic support array at the housing, is fixedly connected to the axle 16a, with the arm 2o being slightly pivoted, which has the result that the frame 16, as shown, is likewise slightly pivoted. In the frame 16, the pivot part 15 is likewise rotatably journaled via the axles 15a so that the pivot part 15 is rotatably journaled both with respect to the axle 15a and with respect to the axle 16a and thus with respect to both dimensions. The arm 2o preferably forms part of a drive apparatus 2, for example of a “rotary voice coil motor”. Such a drive apparatus 2 makes it possible to move the arm 2o very fast. In a preferred aspect, at least one of the combinations of axle 15a/bearing 16b and axle 16a/bearing 17a is made as a friction apparatus 5 to operate the drive apparatus 1 as described in FIGS. 7 to 11. in a further advantageous embodiment, the combinations of axle 15a/bearing 16b and axle 16a/bearing 17a are made as low-friction as possible so that the axles 15a, 16a are movable in easy motion via the first drive apparatus 2 with arm 2o and also via the second drive apparatus 2 with permanent magnet 2d and turns 2e.

In an advantageous embodiment, it is also possible to measure the pivot position of the mirror 4 with respect to the frame 16 by means of induction in that, for example, a wire extends along the frame 16 and is fed with a voltage. The generated field is measure with the winding 2e from which the angle of rotation of the mirror 4 with respect to the frame 16 can be derived. There is a plurality of arrangement possibilities of a coil, in addition to the winding 2e, to measure the angle of rotation of the mirror with respect to the frame 16 in this way by means of induction.

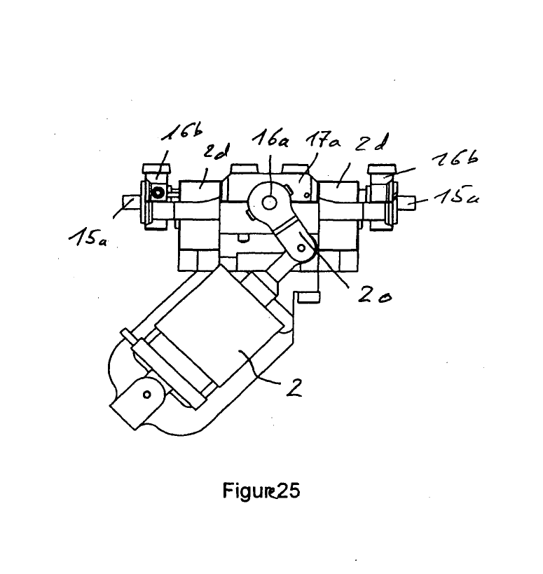

FIGS. 15a to 15f show a further embodiment of a deflection apparatus 1. The difference between the embodiments shown in FIGS. 14c and 15a is essentially that the drive of the frame 16 is made differently. FIG. 15b shows an end face view of the drive or shows a front view of the section arranged at the bottom in FIG. 15a. The frame 16 is connected to the arm 2o via the axle 16a. The shaft 2b of the drive apparatus 2 is connected to an eccentric disk 2p. The eccentric disk includes a cam 2r to which a spring 2q is connected. The spring 2q is additionally connected to the arm 2o so that the arm 2o contacts the eccentric disk 2p and thereby moves along the contour of the eccentric disk 2p on the rotation of the shaft 2b. It is thereby ensured that the rotary movement of the motor 2 or of the shaft 2b is transferred to the frame 16. FIG. 25 shows the same arrangement as in FIG. 15b, but with a linear drive 2 which is rotatably journaled at its ends, with the one end being rotatably connected to the arm 2o so that a length change of the linear drive 2 brings about a pivot movement of the arm 2o. As can be seen from this embodiment, the drive apparatus 2 can be made in a plurality of possibilities to generate a pivot movement. FIG. 15c shows a section along the line I-I. The motor 2, advantageously the motor 2 as shown in FIG. 3, is arranged at the center beneath the base part 17. FIG. 15d shows a section along the section line H-H. FIG. 15d shows a section along the section line G-G. In a preferred aspect, at least one of the combinations of axle 15a/bearing 16b and axle 16a/bearing 17a is made as a friction apparatus 5 to operate the drive apparatus 1 as described in FIGS. 7 to 11. In a further advantageous embodiment, the combinations of axle 15a/bearing 16b and axle 16a/bearing 17a are made as low-friction as possible so that the axles 15a, 16a are movable in easy motion via the first drive apparatus 2 with arm 2o and also via the second drive apparatus 2 with permanent magnet 2d and turns 2e.

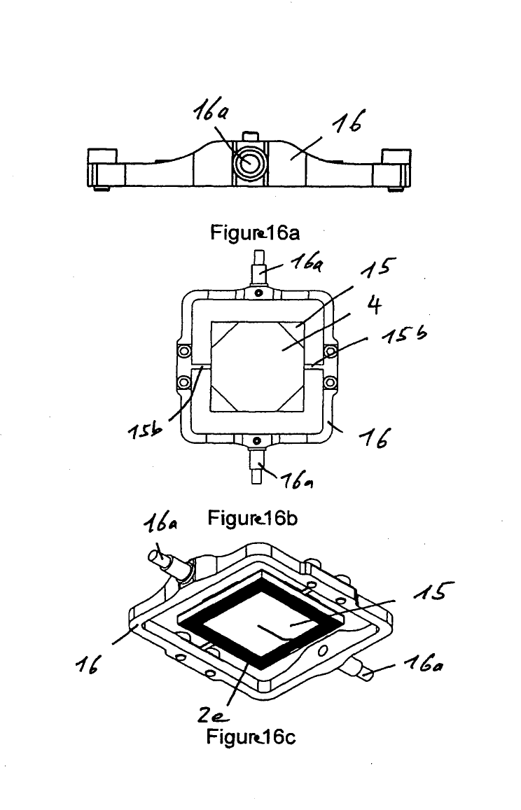

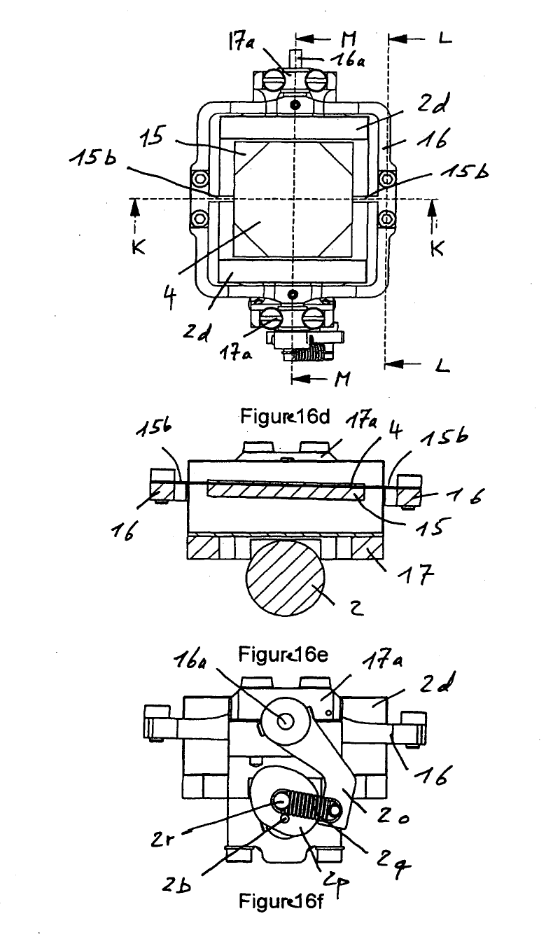

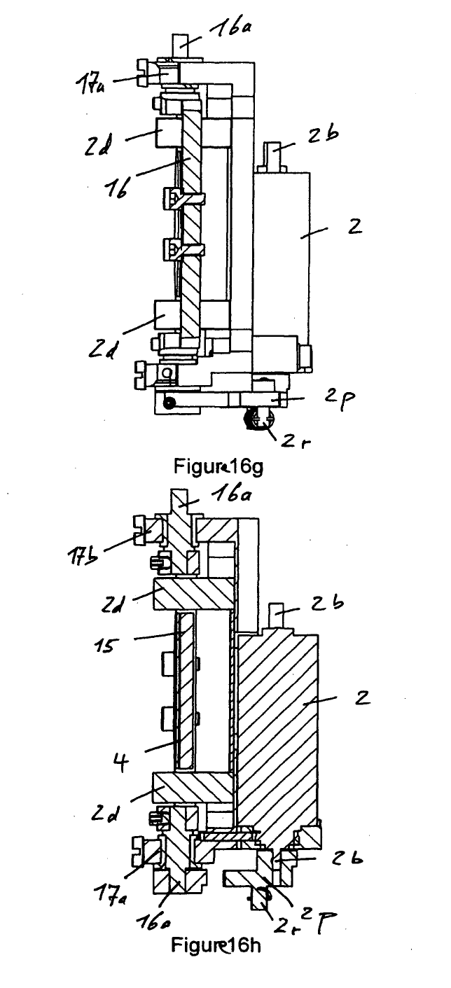

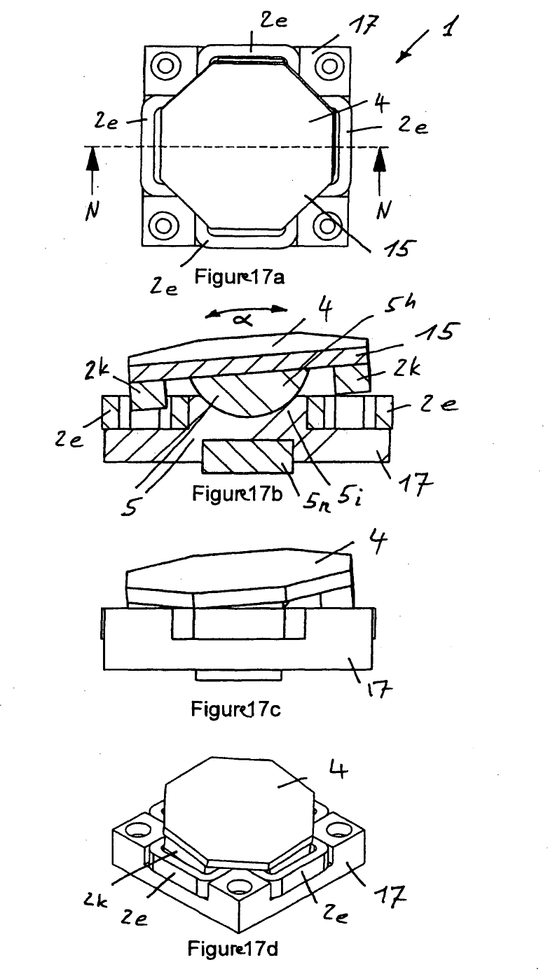

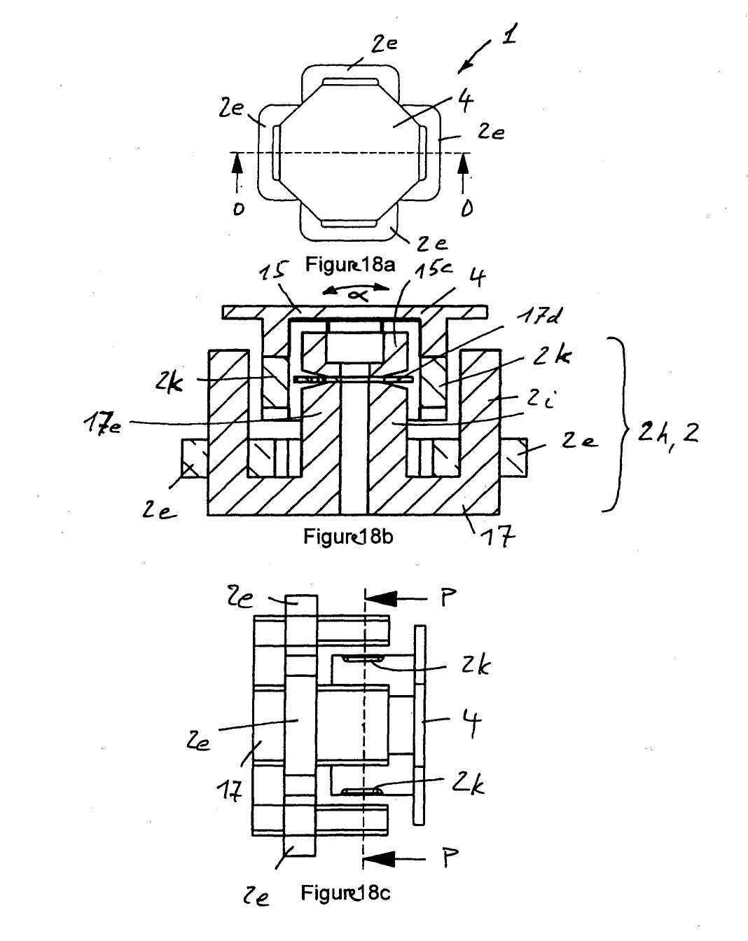

FIGS. 16a to 16h show a further embodiment of a deflection apparatus 1. FIG. 16b shows a plan view of a frame 16 having axles 16 as well as having a pivot part 15 held at the frame 16. Unlike the embodiment shown in FIG. 14b, the pivot part 15 in FIG. 16b is not held via a rotatably journaled axle, but via a flexible connection part 15b. The flexible connection part 15b can, for example, be made as a leaf spring, with the leaf spring advantageously generating a restoring force such that the pivot part 15 automatically adopts a neutral position. As can be seen from the lower view of FIG. 16c, the pivot part 15 includes turns 2e which form part of the drive apparatus 2. FIG. 16a shows a side view of the frame 16 in accordance with FIG. 16b. FIG. 16d essentially shows the arrangement in accordance with FIG. 15a, with the only difference that the pivot part 15 is held via flexible connection parts 15b and not, as shown in FIG. 15a, via an axle 15a with bearing 16b. FIG. 16f shows the end face of the section arranged in the bottom in FIG. 16d. FIGS. 16e, 16g and 16h show cuts along the section lines K-K or L-L and MM.

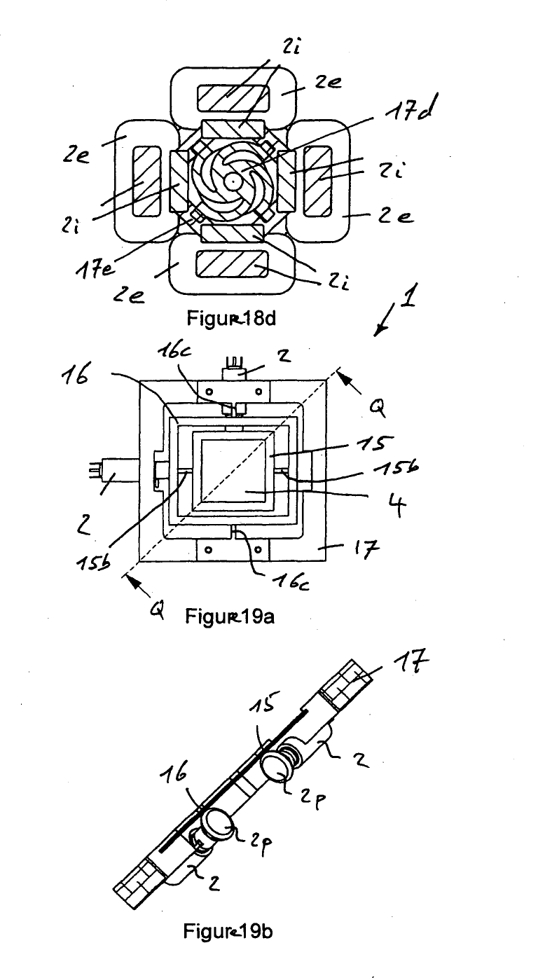

FIGS. 17a to 17d show a further embodiment of a deflection apparatus 1. As shown in FIG. 17a, the deflection apparatus 1 includes a base part 17 having four magnetic coils 2e as well as a pivotably journaled pivot part 15 with a mirror 4. FIG. 17b shows in a longitudinal section along the section line N-N that the mirror 4 is pivotably journaled via a friction apparatus 5 with respect to the base part 17, with the friction apparatus 5 including a semi-spherical part 5h as well as a corresponding part 5i having a semi-spherical recess. A respective armature 2k is attached oppositely disposed on the pivot part 15 and comes into operational connection with the correspondingly arranged magnetic coil 2c, with the armatures 2k and magnetic coils 2e shown in FIG. 17b forming a drive apparatus 2 which permits the pivot part 15 to be pivoted in the direction of the angle Δα. In an embodiment, the semi-spherical part 5h could be made, for example, as a magnetic part and the part 5n could be made as a permanent magnet so that the semi-spherical part 5h is held in the base part 17 via magnetically acting forces. FIG. 17c shows a side view and FIG. 17d shows a perspective view of the deflection apparatus 1.

FIGS. 18a to 18d show a further embodiment of a deflection apparatus 1. As shown in FIG. 18a, the deflection apparatus 1 includes four magnetic coils 2e as well as a pivotably journaled pivot part 15 with a mirror 4. FIG. 17b shows in a longitudinal section along the section line O-O that the mirror 4 is pivotably journaled via a spring 17d with respect to the base part 17 or to the connection part 17e. A respective armature 2k is attached oppositely disposed on the pivot part 15 and comes into operational connection with the correspondingly arranged magnetic coil 2e and with the magnetically conductive parts 2i, with the armatures 2k and magnetic coils 2e shown in FIG. 18b forming a drive apparatus 2 which permits the pivot part 15 to be pivoted in the direction of the angle Δα. FIG. 18c shows a side view of the deflection device 1. FIG. 18d shows a section along the section line P-P. In particular the magnetically conductive parts 2i as well as the magnetic coils 2e can be seen from it. The spring 17d is additionally shown in section. This spring 17d is outwardly connected to the connection part 17e and is connected at the center to the connection part 15c so that the pivot part 15 is pivotably journaled with respect to the connection part 17e.

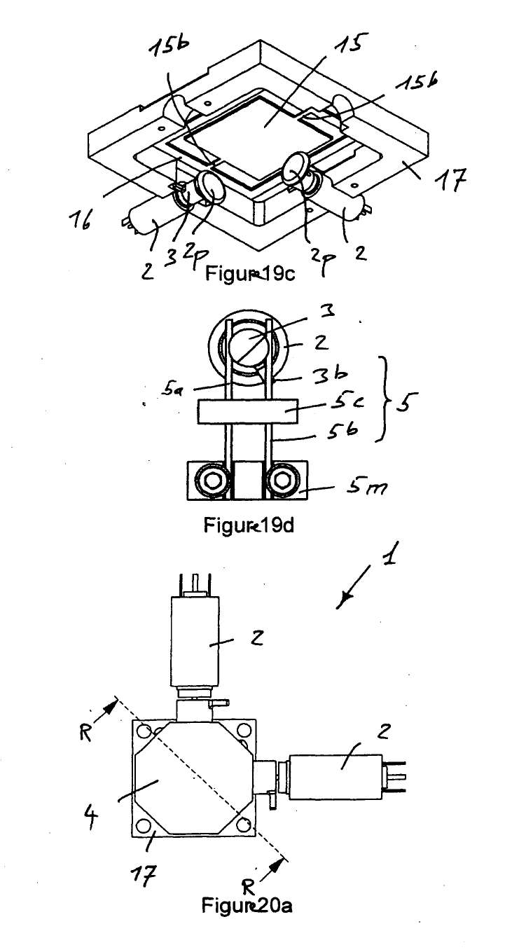

FIGS. 19a to 19d show a further embodiment of a deflection apparatus 1. The pivot part 15 with a mirror 4 is connected to the frame 16 via an elastically deformable connection part 15b. The frame 16 is connected to the base part 17 via an elastically deformable connection part 16c. In addition, two drive apparatus 2 can be seen. FIG. 19b shows a section along the section line Q-Q. Each motor 2 is connected to an eccentric disk 2p, with the one eccentric disk 2p acting on the pivot part 15 and the other eccentric disk 2p acting on the frame 16. FIG. 19c shows the deflection apparatus 1 shown in FIG. 19a from below. The friction apparatus 5 can be produced by the friction force arising between the eccentric disk 2p and the pivot part 15 or the frame 16. In a further embodiment, however, the friction apparatus 5 shown in FIG. 19d can, for example, also be used which, similar to as shown in FIGS. 1 to 3, acts on a connection part 3 and brings about static friction and sliding friction on the connection part 3 via wires 5a, 5b and a holding part 5m. In a preferred embodiment, the connection parts 15b and 16c bring about such a restoring force that the pivot part 15 or the frame 16 preferably constantly contact the eccentric disk 2p in every pivot position. This has the result that the connection parts 15b and 16c have to generate a torque in the natural position or central position shown in FIGS. 19a to 19c so that the frame 16 or the pivot part 15 contracts the eccentric disk 2p reliably and also during the further pivoting.

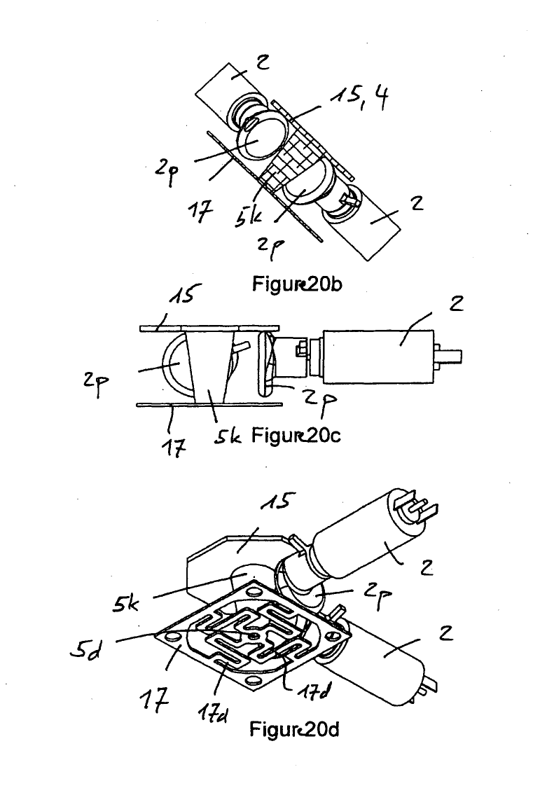

FIGS. 20a to 20d show a further embodiment of a deflection apparatus 1. FIG. 20a shows the drive apparatus 1 with mirror 4, base part 17 and to drive apparatus 2 in a plan view. As shown in FIG. 20b, the pivot part 15 with mirror 4 is connected to the base part 17 via a connection part 5k. The two electric motors 2 are arranged offset by 90 degrees and each have an eccentric disk 2p which acts at the bottom of the pivot part 15. FIG. 20c shows a further side view of the arrangement shown in FIG. 20b. FIG. 20d shows a perspective view from below. The base part 17 has four springs 17d which extend in meander-like shape and meet at a common bore 5d. The connection part 5k is fixedly connected to the bore 5d via a screw which is not shown. The base part 17 is fixedly arranged, whereas the bore 5d is movable via the springs 17d with respect to the base part 17. The eccentric disks 2p engaging at the pivot part 15 bring about a lifting of the pivot part 15 so that the pivot part is movably journaled with respect to two dimensions. The friction apparatus 5 could be made as described in the embodiment in accordance with FIG. 19.

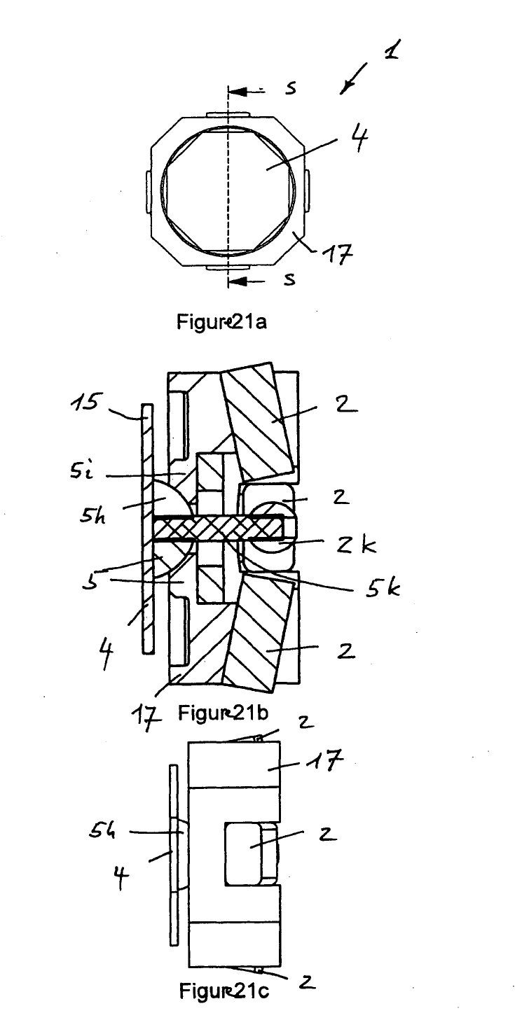

FIGS. 21a to 21d show a further embodiment of a deflection apparatus 1. FIG. 21a shows the drive apparatus 1 with mirror 4 and base part 17 in a plan view. FIG. 21b shows a longitudinal section along the section line S-S. The pivot part 15 with mirror 4 is pivotably journaled in the base part 17 via a semi-spherical part 5h and a corresponding recess 5i. An armature 2k is connected to the part 5h via a connection part 5k. Four magnets made as drive apparatus 2 are arranged offset by 90 degrees in each case in the peripheral direction to move the armature 2k in an X direction and in a Y direction, which has the result of a pivot movement of the pivot part 15. FIG. 21c shows a side view and FIG. 21 a perspective view from below.

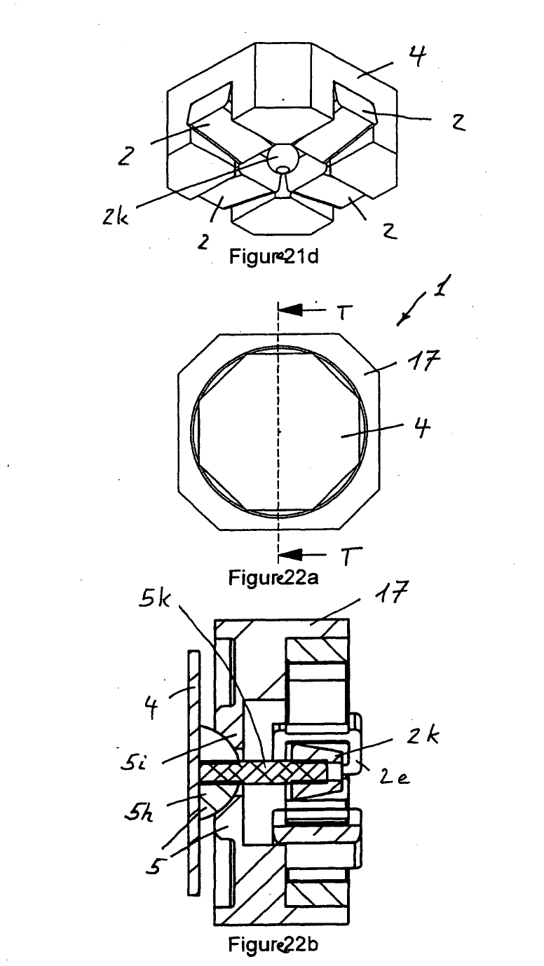

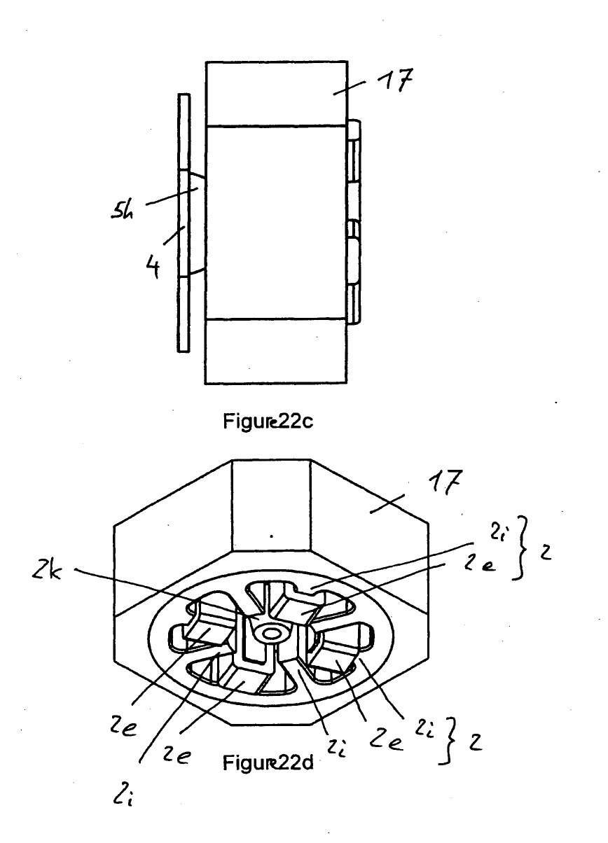

FIGS. 22a to 22d show a further embodiment of a deflection apparatus 1. FIG. 22a shows the drive apparatus 1 with mirror 4 and base part 17 in a plan view. FIG. 22b shows a longitudinal section along the section line T-T. The pivot part 15 with mirror 4 is journaled pivotably in the base part 17 via a semi-spherical part 5h and a corresponding recess 5i. An armature 2k is connected to the part 5h via a connection part 5k. Four magnets 2 with coils 2e and magnetic core 2i made as drive apparatus 2 are arranged offset by 90 degrees in each case in the peripheral direction to move the armature 2k in an X direction and in a Y direction, which has the result of a pivot movement of the pivot part 15. FIG. 22c shows a side view and FIG. 22 shows a perspective view from below.

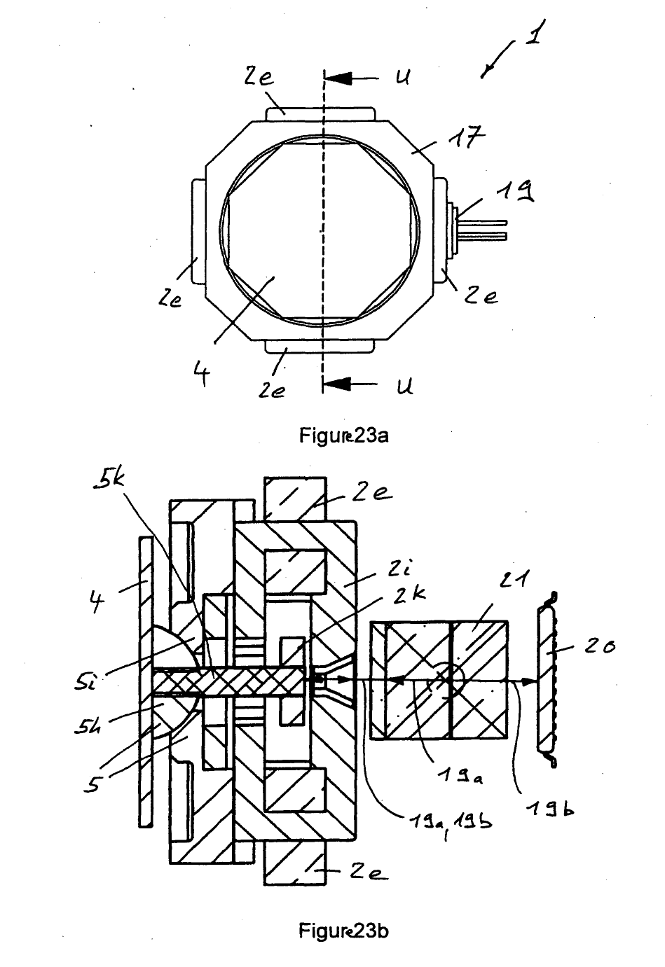

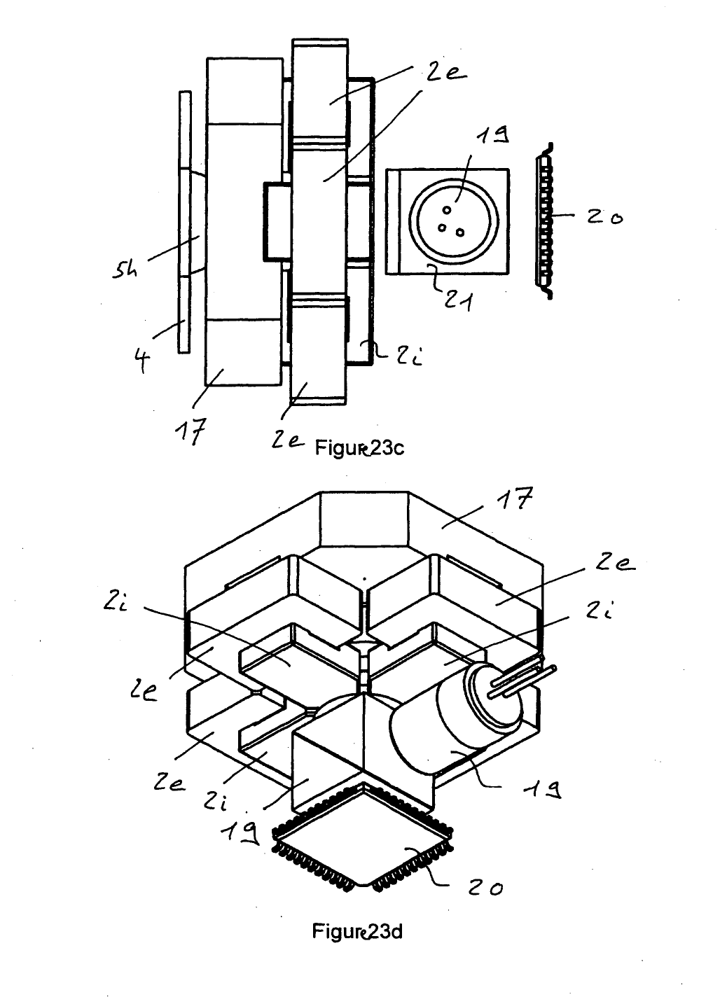

FIGS. 23a to 23d show a further embodiment of a deflection apparatus 1. FIG. 23a shows the drive apparatus 1 with mirror 4, base part 17, magnetic coils 2e and a light source or a laser 19 in a plan view. FIG. 22b shows a longitudinal section along the section line U-U. The pivot part 15 with mirror 4 is pivotably journaled in the base part 17 via a semi-spherical part 5h and a corresponding recess 5i. An armature 2k is connected to the part 5h via a connection part 5k. Four magnets 2 with coils 2e and magnetic core 2i made as drive apparatus 2 are arranged offset by 90 degrees in each case in the peripheral direction to move the armature 2k in an X direction and in a Y direction, which has the result of a pivot movement of the pivot part 15. At the right, a beam splitter 21 is arranged which directs the laser beam of the LED 19 as an incident beam 19a to the end face of the connection part 5k, where the beam is reflected, and as a reflected beam 19b to a two-dimensional sensor 20, for example to a CCD chip. The deflection of the connection part 5k and thus the deflection of the mirror 4 can be detected using this arrangement. FIG. 23c shows a side view and FIG. 23 a perspective view from below.

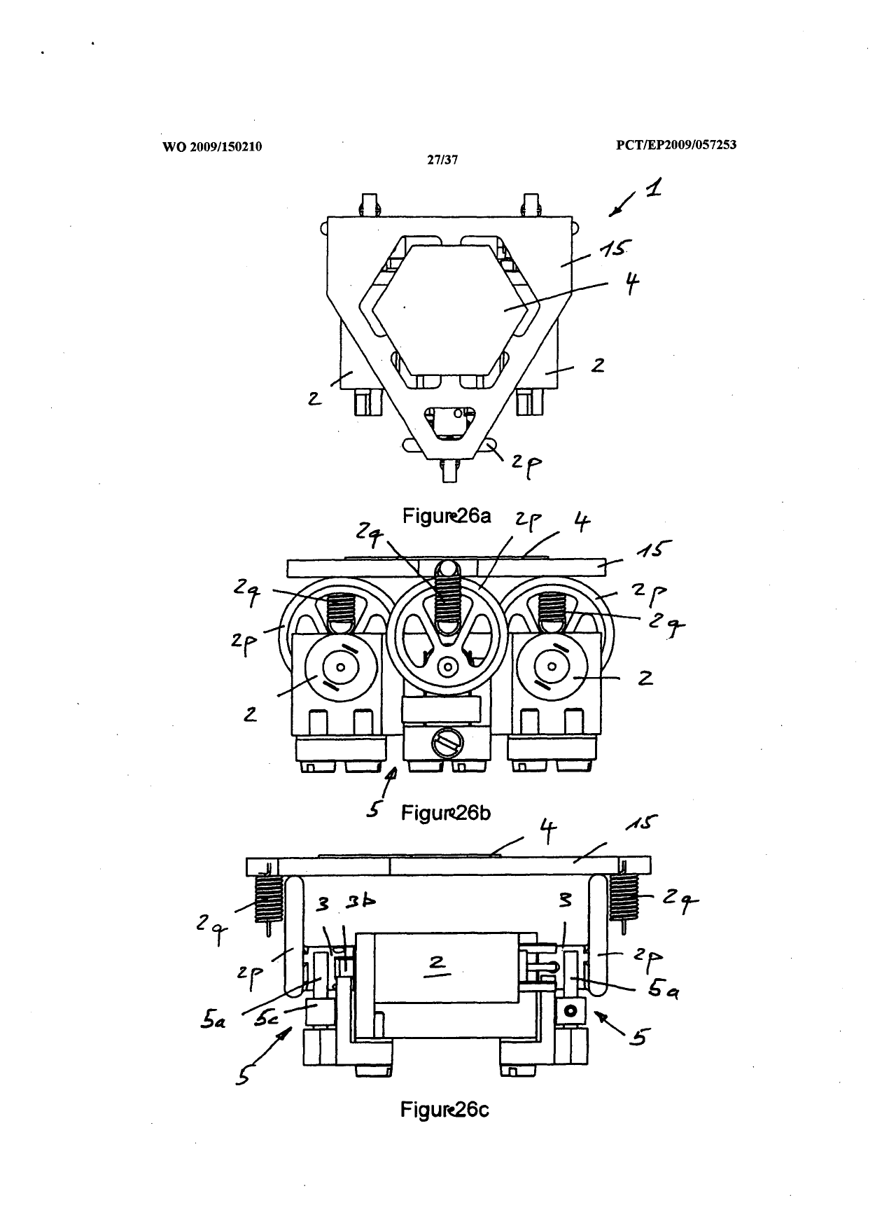

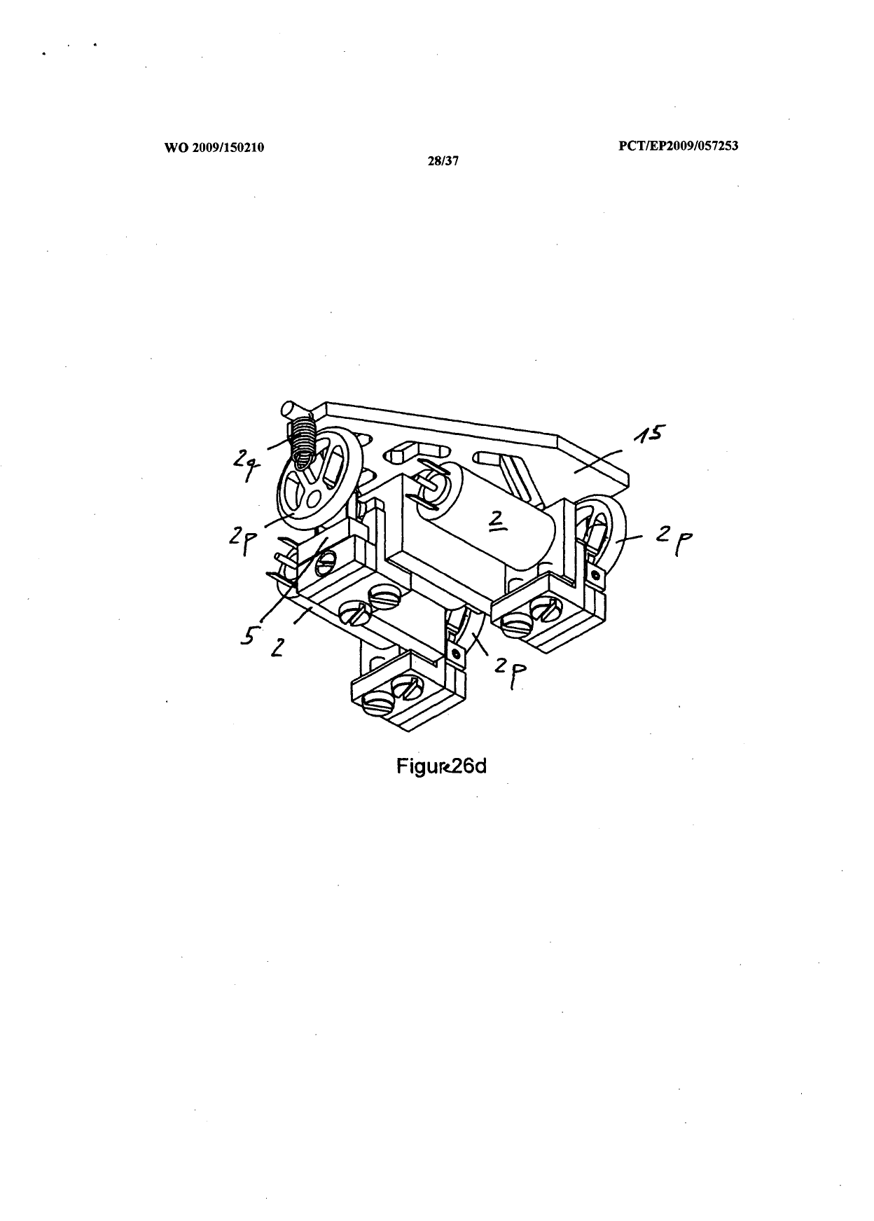

FIGS. 26a to 26d show a further embodiment of a deflection apparatus 1. The pivot part 15 with mirror 4 is connected to a fixed position base part, not shown, via springs 2q, preferably via three springs 2q, or directly to the eccentric disks 2p using bolts, and indeed such that the spring 2q has the same spacing from the pivot part 15, and thus the same counter-force of the eccentric disk 2p onto the pivot part 15, at any position of the bolt at the eccentric disk 2p. The bolt at the eccentric disk 2p must likewise be arranged eccentrically to the motor axis for this purpose. FIG. 26b shows a side view of FIG. 26a. Each motor 2 is connected to an eccentric disk 2p, with each eccentric disk 2p contacting the pivot part 15 directly so that a rotation of the respective eccentric disk 2p results in a corresponding deflection of the pivot part 15 since the pivot part 15 contacts the eccentric disks 2p under spring force of the springs 2q. FIG. 26c shows a side view of FIG. 26a from the left. Each motor 2 is connected to a respective eccentric disk 2p via a connection part 3 with stop 3b, with moreover a similar braking apparatus 5 as shown in FIG. 19d being arranged with a wire/resilient sheet metal/brake part or friction part 5a, 5b and holding part 5c. Instead of this braking apparatus 5, the braking force and friction force could also, as described in connection with FIGS. 19a to 19d, be generated by the friction force acting between the eccentric disk 2p and the pivot part 15. FIG. 26d shows the laser scanner 1 in a perspective view from below.

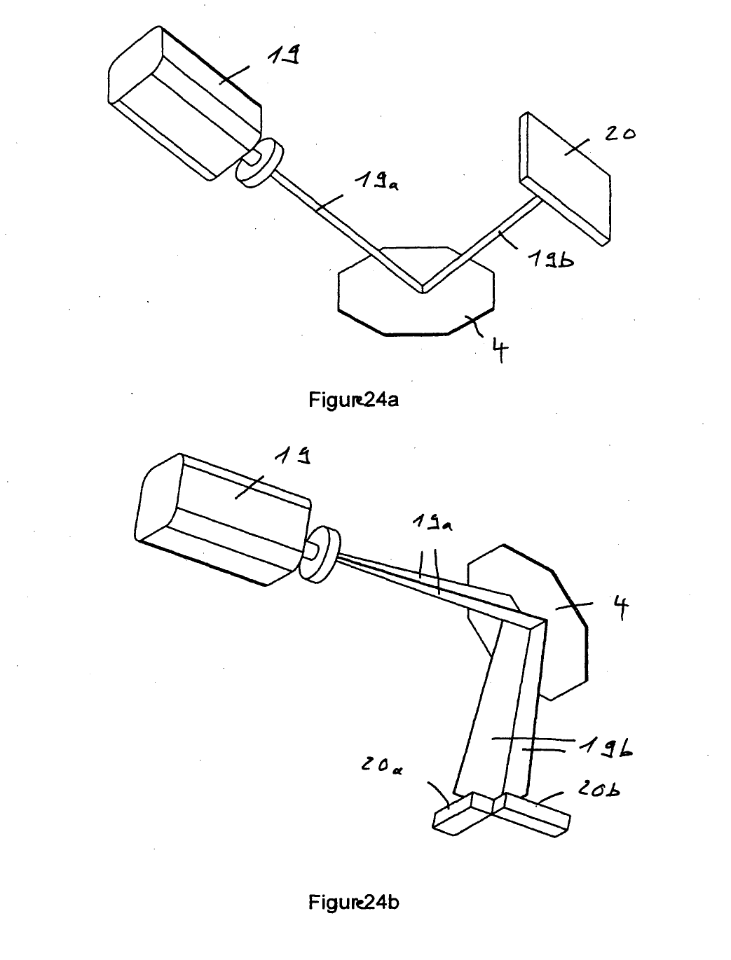

FIG. 24a shows a further embodiment of detecting the deflection of the deflection apparatus 4 or of a pivot part 15, preferably of the mirror 4. A laser 19 generates a laser beam 19a which is reflected at the mirror 4, with the reflected laser beam 19b being directed to an areal CCD sensor or to a PSD (position sensitive device). With respect to the deflection apparatus 4, a plurality of different positions can be suitable to reflect an incident laser beam 19a and to supply the reflected laser beam 19b to a sensor 20. As shown in FIG. 23b, further components which move with the deflection apparatus 4, such as the armature 2k or the lower side of the deflection apparatus 4 or the lower side of the mirror 4, can also be suited to detect the precise deflection of the deflection apparatus 4 from the laser beam 19a deflected thereby. The deflection of the deflection apparatus 4 can also be determined indirectly, for example in that the angle of rotation of the drive apparatus 2 is measured and the deflection of the deflection apparatus 4 is calculated therefrom. To measure the deflection of the deflection apparatus 4 as precisely as possible and without error, it is, however, particularly advantageous to measure the deflection of the deflection apparatus 4 directly.

FIG. 24b shows a further embodiment which, unlike the embodiment shown in FIG. 24a, uses a laser device 19 which generates a laser beam 19a which generates linear laser beams, for example, as shown, two lines extending mutually perpendicular or an L-shaped laser beam or, for example, a cruciform laser beam. As shown in FIG. 24b, each line of the reflected laser beam 19b is incident on a linear sensor 20a, 20b. The sensors 20a, 20b are preferably arranged mutually offset by 90°. An advantage of the embodiment shown in FIG. 24b is the fact that linear sensors 20a, 20b are very cost-effective and are also very fast with respect to signal detection so that this arrangement allows a cost-effective detection, and in particular also a fast detection, of the position of an object, for example of the mirror 4, via the reflection of a laser beam. The L-shaped laser beam shown can, however, also only be a line laser which is only projected onto a single linear sensor.

There is a plurality of embodiments to measure the position of an object such as the deflection of the mirror 4 so that the embodiment disclosed in FIGS. 23a to 24b only represents one of a plurality of possibilities. The deflection of the mirror can also be determined, as described in FIGS. 1 to 9, with the help of the drive apparatus 2.

FIGS. 32a and 32b show two embodiments for the measurement of the deflection of the mirror 4. In FIG. 32a, the laser beam 6 to be deflected and the auxiliary laser beam 19a required for the position measurement are incident onto the mirror 4 from the same side. In FIG. 32b, the laser beam 6 to be deflected is incident on the one side of the mirror 4 and the auxiliary laser beam 19a required for the positional measurement is incident on the rear side of the mirror 4. The embodiment in accordance with FIG. 32a has the advantage that the mirror 4 only requires a specularly reflecting surface on one side. The embodiment in accordance with FIG. 32b has the advantage that a more compact construction of the laser scanner 1 is thereby possible.

FIG. 27a shows a preferably cruciform laser beam 19a, as shown in FIG. 24b, which is reflected as the first reflected beam 19b and as the second reflected beam 19c from the mirror 4. The optical transmission of the laser beam 19a frequently brings about a shape change so that the reflected beams have the elliptical shape shown by the beams 19b, 19c at the measured position, for example. The sensor 20a, 20b is made as a linear array with a plurality of pixels arranged next to one another and shown as squares. Each pixel preferably has a specific light sensitivity, for example of 12 bits. Even if the linear width of the beams 19b, 19c is, as shown, not constant, the position of the beam 19b, 19c can be precisely determined with respect to the sensor 20a, 20b by a corresponding averaging since the beam 19b, 19c is incident on a plurality of pixels simultaneously. This aspect thus has the advantage that the deflection of a beam 19b, 19c can also be measured precisely with a non-homogeneous beam profile. This arrangement in accordance with the invention thus permits a reliable and precise determination of the deflection of the mirror 4.

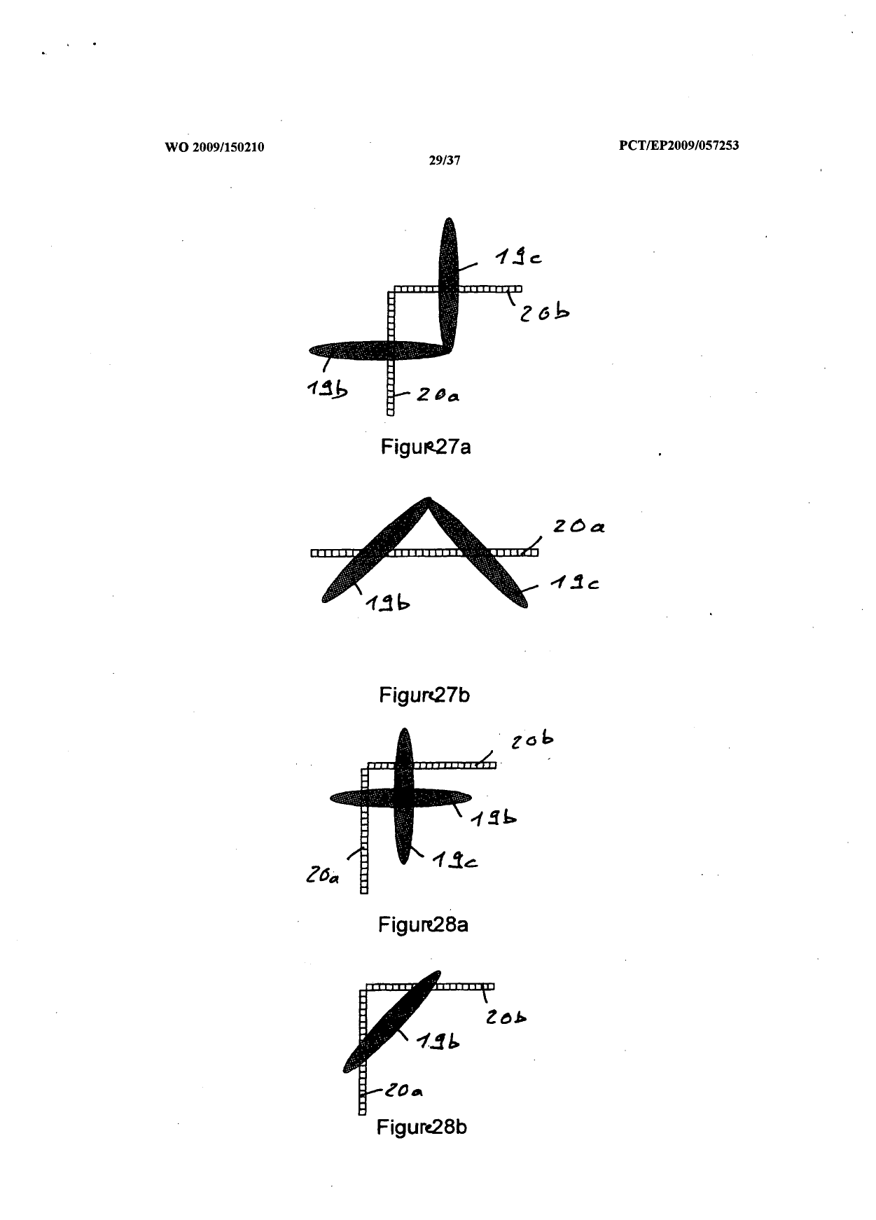

FIG. 27b shows the same beams 19b, 19c already shown in FIG. 27a. Since the pixels of the sensor 20a can preferably be measured individually, it can also be determined which values measured by the sensor 20a are to be associated with the beam 19b and which are to be associated with the beam 19c since pixels disposed directly next to one another are illuminated by the same beam 19b, 19c. It is therefore possible to measure the two-dimensional deflection of the mirror 4 with a single pixel array preferably extending in a linear fashion. FIGS. 28a and 28b show further arrangements of sensors 20a, 20b and of incident beams 19b, 19c to measure the deflection of the mirror 4, similar to as described in FIGS. 27a and 27b. The embodiment in accordance with FIG. 28a, for example, allows an autocross laser to be used to generate the incident light beam 19a. The embodiment in accordance with FIG. 28a, for example, allows a very cost-effective line laser to be used to generate the incident light beam 19a.

Generally, the beams 19b and 19c can be generated by means of a laser and a somewhat more complex and/or expensive optical system for beam shaping (for example DOE—diffractive optical element) or also by means of two lasers and a respective simpler optical system.

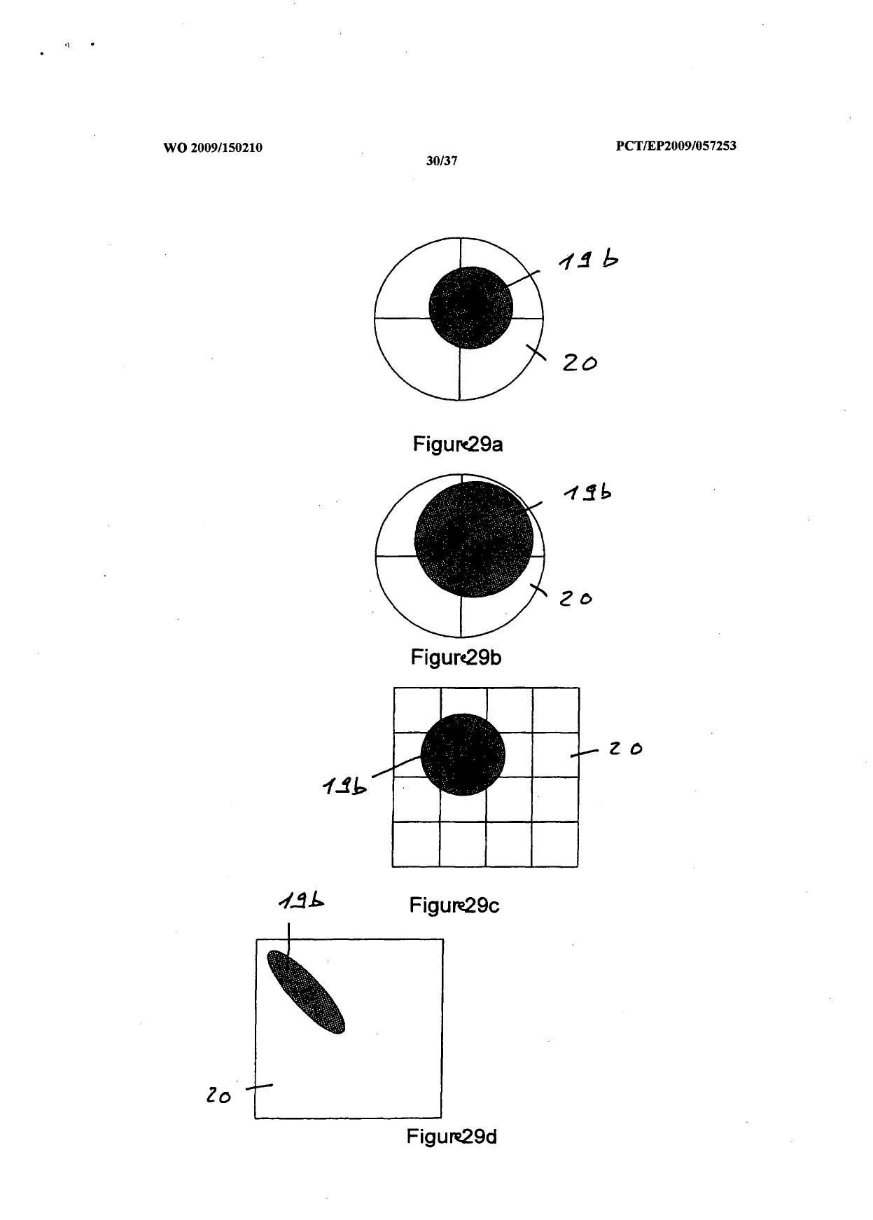

FIGS. 29a and 29b show the use of a four-quadrant sensor 20 for the measurement of the position of the reflected beam 19b. A four-quadrant sensor 20 includes four measurable squares so that the center of the beam 19b can be determined via the radiation intensity incident onto each quadrant.

FIG. 29c shows the use of a two-dimensional array of pixels for the measurement of the position of the reflected beam 19b. The array can, for example, have a pixel number of 2×2 up to 1024×1024 or even more. A CCD chip or a photodiode array are suitable, for example.

FIG. 19d shows a PSD (position sensitive device) for the measurement of the position of the reflected beam 19b. The PDS is described in connection with FIGS. 23a to 23d.

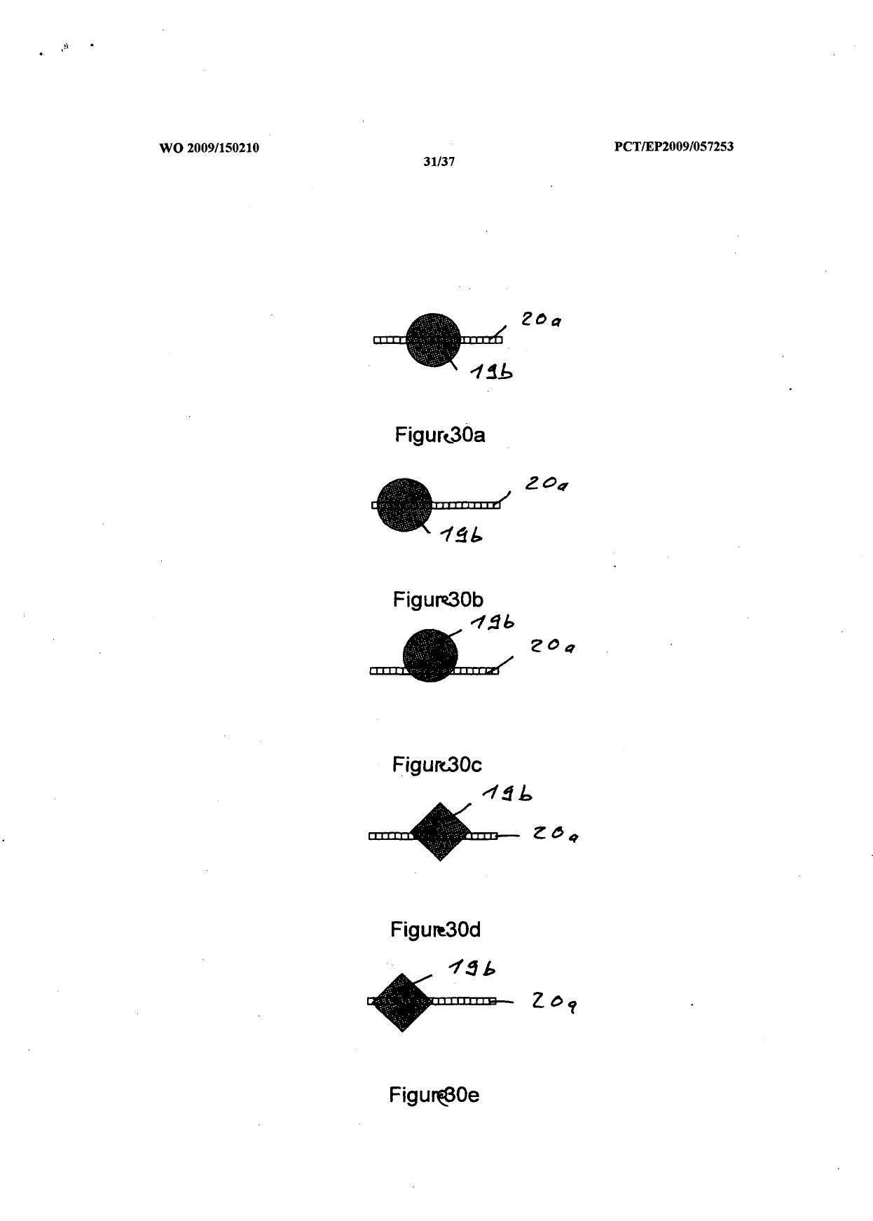

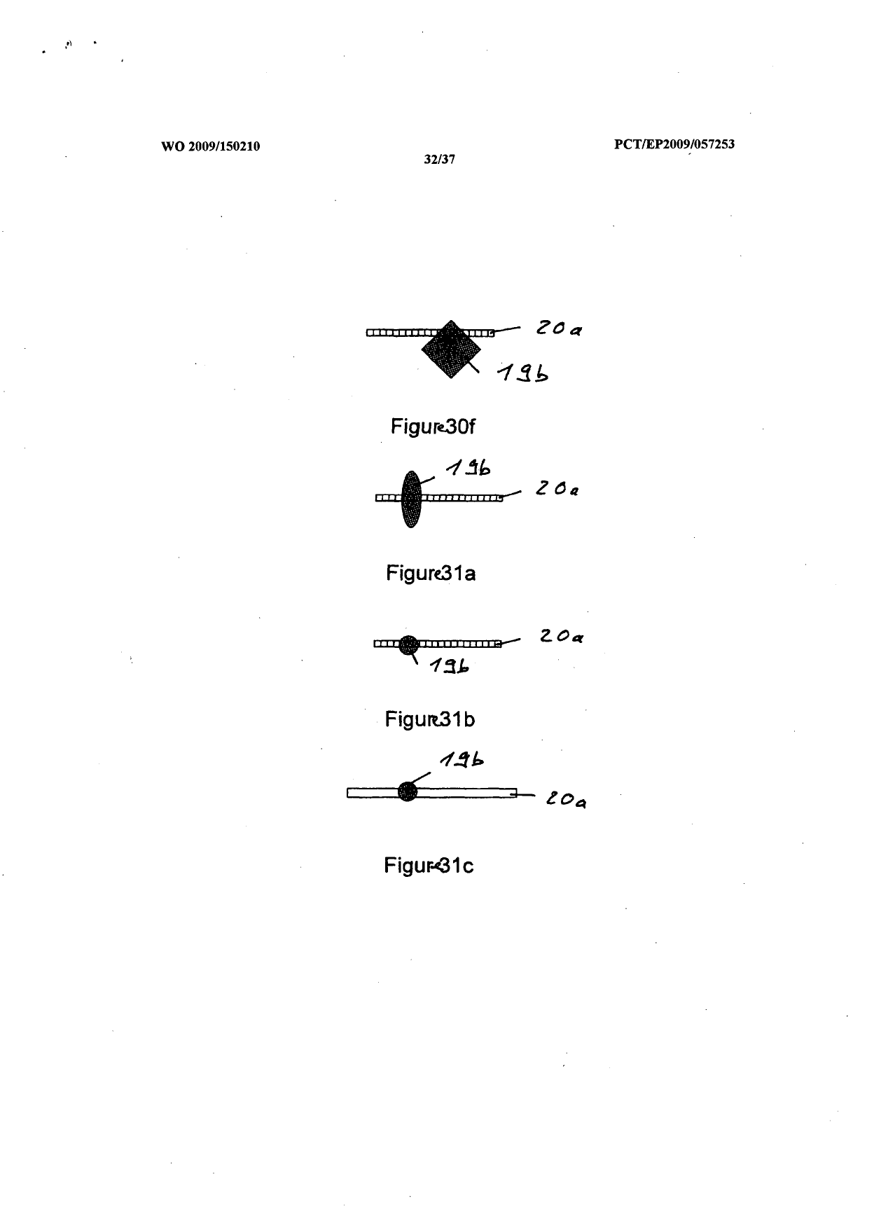

FIGS. 30a to 30c disclose how the deflection of the reflected beam 19b in the X and Y directions can be measured using a line sensor 20a including a plurality of individual measurable pixels. FIG. 30a shows a center position X=Y=0. FIG. 30b shows a position with a deflected X axis, for example X=5 and Y=0 and FIG. 30c shows a position with a deflected Y axis, for example X=0 and Y=5. The X axis is usually simple to evaluate. It applies with respect to the Y axis: fewer pixels are illuminated with the displacement of the point 19b. The position in the X and Y directions can be determined from the known diameter of the point 19b on the sensor 20a and from the number of illuminated pixels. Instead of a beam 19b reflected in circular shape, the beam can, as shown in FIGS. 30d to 30f, also have a different shape. Here, for example, the rectangle has the advantage that the change in the position can be detected more easily due to the steep flanks; however, the laser requires an additional optical system for the rectangular beam profile. A determination of the X and Y positions is possible with a plurality of shapes of the incident reflected laser beam 19b. Circular, triangular, square, rectangular, polygonal and elliptical shapes are suitable as shapes, for example.

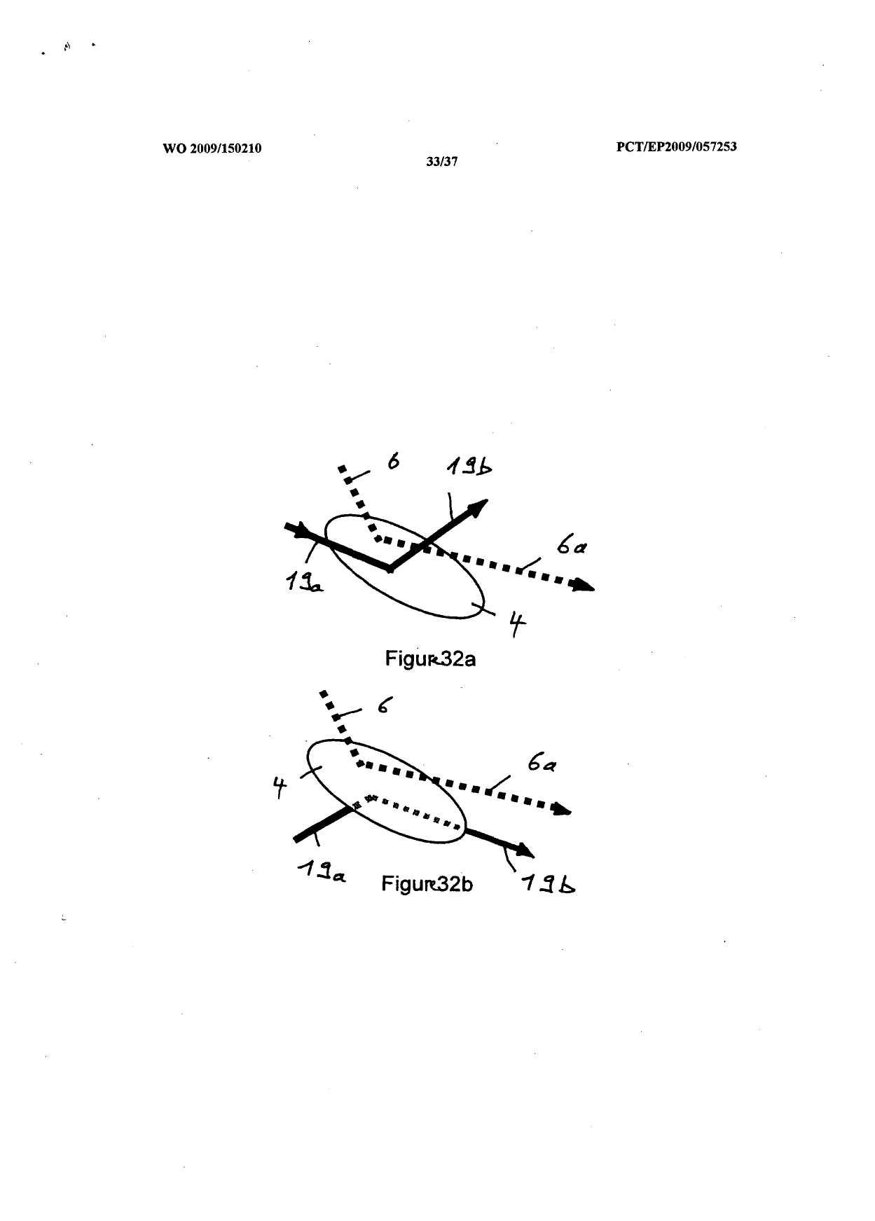

FIGS. 31a to 31c show possibilities of measuring the deflection of a reflected beam 19b in only one dimension. FIG. 31a shows a linear sensor 20a with a plurality of individually measurable pixels and a beam 19b of oval shape. FIG. 31b shows the same arrangement as in FIG. 31a, with the beam 19b having a round shape. FIG. 31c shows a round beam 19b which is incident onto a linear or one-dimensional PDS (position sensitive device) sensor.

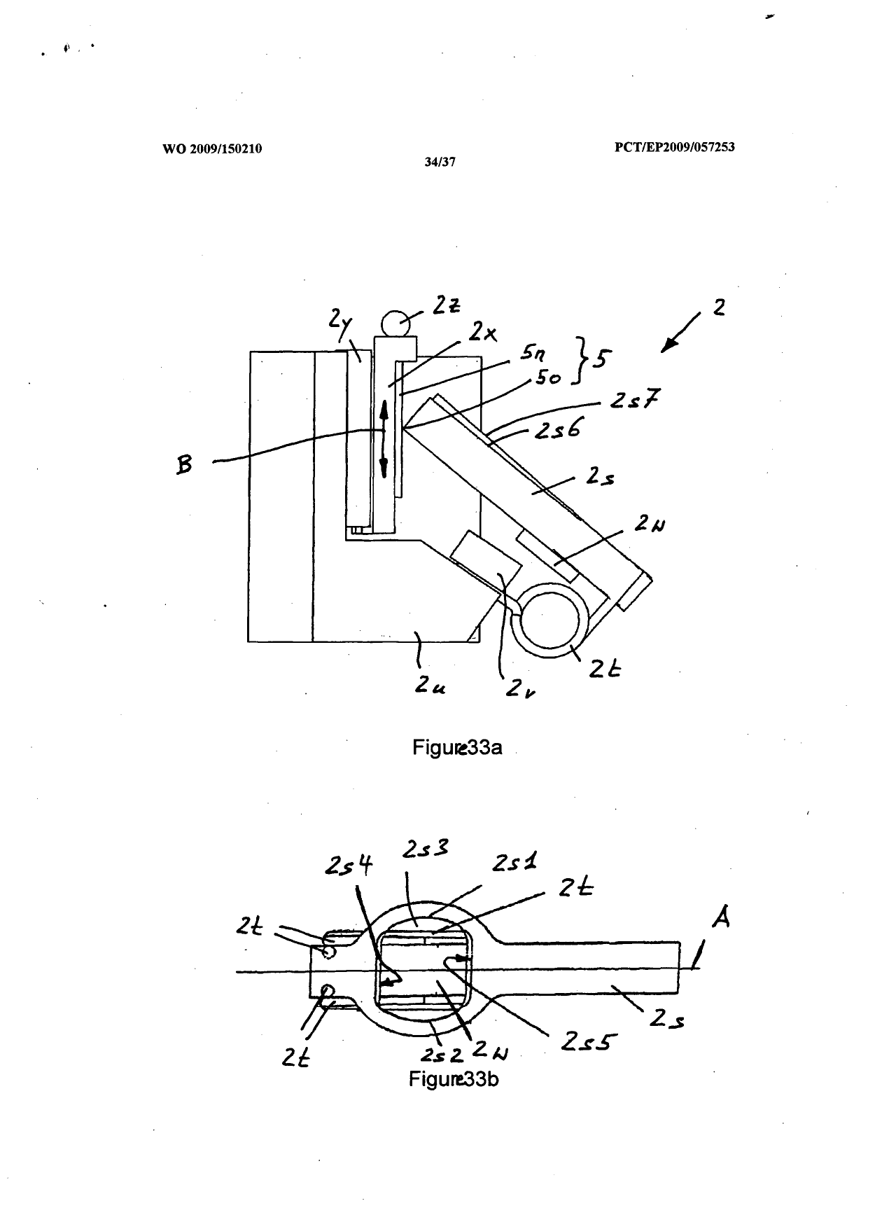

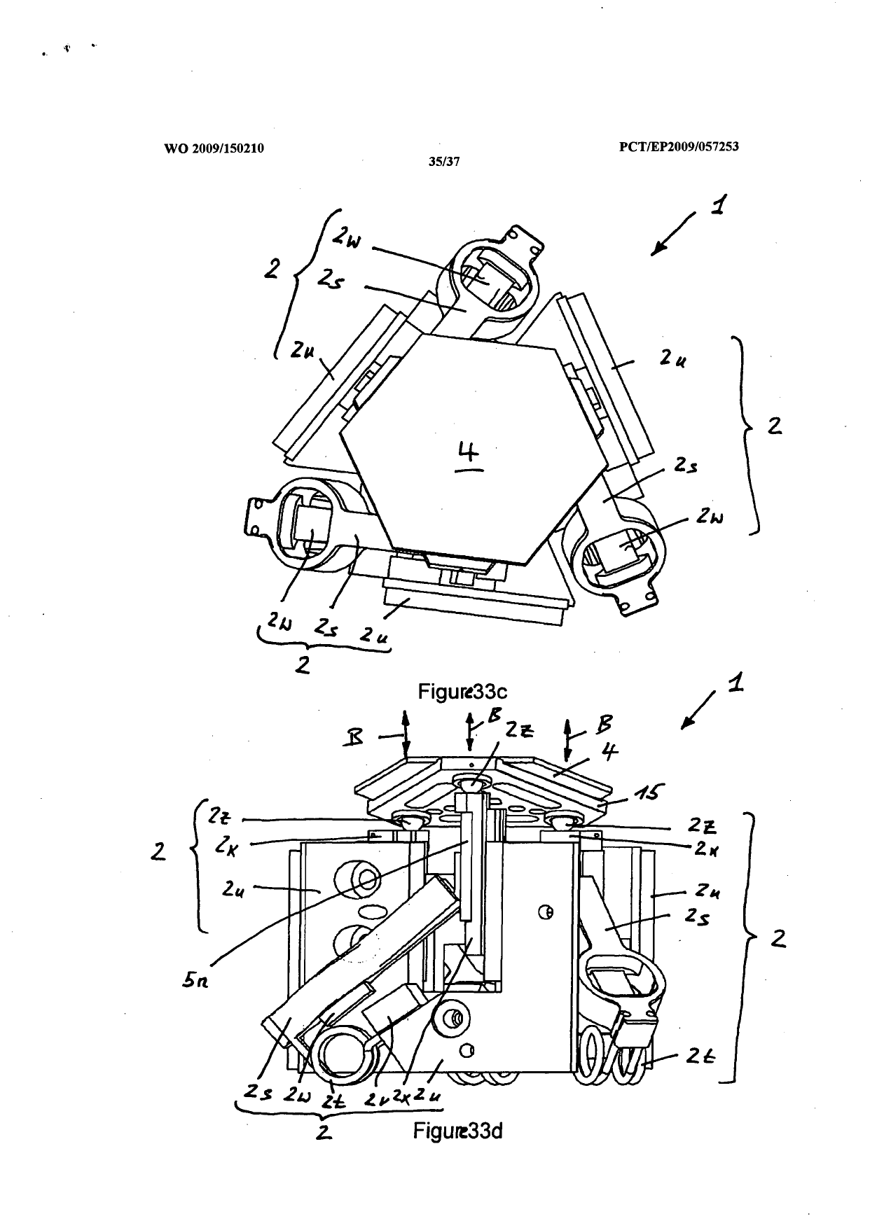

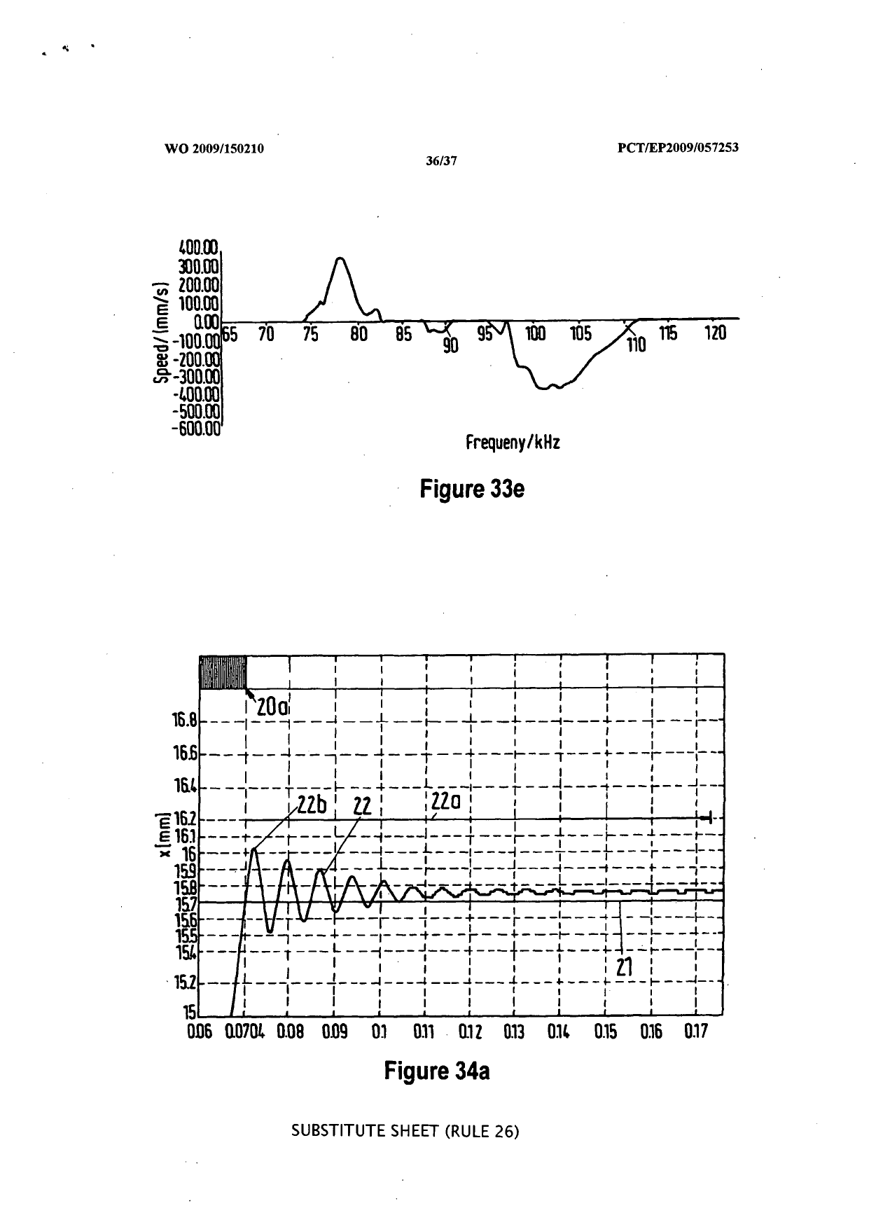

FIGS. 33a to 33d show a further embodiment of a deflection apparatus 1. The drive apparatus 2 comprises a piezoelectric drive. Details about such piezoelectric drives and there operation are disclosed in U.S. Pat. No. 7,173,362, U.S. Pat. No. 6,870,304, U.S. Pat. No. 6,825,592, U.S. Pat. No. 6,690,101, U.S. Pat. No. 6,664,714, U.S. Pat. No. 7,187,102, U.S. Pat. No. 7,224,099, U.S. Pat. No. 7,342,347, U.S. Pat. No. 7,368,853 or U.S. Pat. No. 7,436,101, all these patents are hereby incorporated by reference.

FIG. 33a shows a side view of drive device 2 including a friction apparatus 5, wherein the drive device 2 comprises a piezoelectric motor. The drive device 2 includes a rigid body 2u. The drive device 2 further includes a resonator 2s comprising a piezoelectric component 2w and a coil spring 2t, whereby the coil spring 2t is attached to the rigid body 2u by fixation means 2v. The drive device further includes a linear guide 2y attached to the rigid body 2u and a slider 2x, which is guided by the linear guide 2y so that the slider 2x can move in direction B of the linear guide 2y. A ball 2z, for example a ruby ball, is arranged at the upper front end of the slider 2x. The slider 2x further comprising a linear body 5n attached to the slider 2x and extending in the moving direction B. The resonator 2s comprising a front end or tip 5o which touches the linear body 5n, thereby forming, inter alia, a friction apparatus 5. The resonator 2s is activated by the piezoelectric component 2w in such a way, that the tip 5o acts onto the linear body 5n in a way that the slider 2x is moved in direction B. During operation of the drive device 2, the resonator 2s is vibrating and therefore in particular the front end of the resonator 2s is moving to different positions, whereby two of the plurality of possible positions are indicated by 2s6 and 2s7. Depending on the frequency of activating resonator 2s, slider 2x is moved in one or the other direction B, which in the view of FIG. 33a means, in the upward or downward direction B.

FIG. 33b shows a top view of the piezoelectric motor, which is part of drive device 2. The piezoelectric motor 2 comprises an opening 2s3 that is formed by sidewalls 2s1, 2s2. A piezoelectric component 2w is clamped within the opening 2s3 between the contact surfaces 2s4, 2s5. Furthermore, the resonator 2s is connected to a coil spring 2t. The piezoelectric component 2w and the coil spring 2t are configured in such a way with respect to the resonator 2s that the resonator's symmetry is disturbed in a predetermined manner and that the symmetry plane of the piezoelectric motor 2 (not shown) does not coincide with the symmetry plane A of the resonator 2s. As disclosed in FIG. 33a the drive device 2 further comprises a rigid body 2u the coil spring 2t is attached to, and a slider 2x movably arranged with respect to the rigid body 2u, whereby the front end 5o of the resonator 2s and the rigid body 2u and its linear body 5n are arranged in such a way, that the front end 5o may act onto the linear body 5n so that the vibrating resonator 2s may move the slider 2x in direction B. In addition the front end 5o and the linear body 5n form a friction apparatus 5, in particular when the resonator 2s doesn't vibrate and the front end 5o of the resonator 2s being in touch with the linear body 5n of the slider 2x. Most preferably the material of the linear body 5n and the front end 5o is selected such, that when the resonator 2s doesn't vibrate the static friction between the linear body 5n and the front end 5o causes a self blocking, so that the linear body 5n is blocked and cannot move.

The drive device 2 shown in FIGS. 33a and 33b works as follows. The piezoelectric component 2w comprises a ceramic material that transforms electrical energy into mechanical energy and visa versa. The resonator 2s is preferably a metal frame, for example aluminum. The piezo ceramic component 2w is fit into the resonator 2s in the opening 2s3. A high frequency voltage is applied to the piezo ceramic component 2x.

Through a special form factor and geometry of the resonator 2s, the tip 5o of the resonator 2s will describe elliptical movements, at a specific resonant frequency. If the tip 5o is pushed against the linear body 5n, the elliptical movement will push or pull the linear body 5n and the connected slider 2x moves back or forward in direction B. The drive device 2 can run in two opposite directions B depending on the frequency applied. As shown in the example of FIG. 33e a frequency in the range between about 75 kHz and 80 kHz causes a positive speed in the range of up to about 350 mm per second, whereas a frequency in the range between about 97 kHz and 110 kHz causes a negative speed in the range of up to about −350 mm per second. Therefore depending on the frequency applied onto the piezo ceramic component 2w, the slider 2x is moved back or forward in direction B. For this purpose, an embodiment is preferred wherein the resonator portion contacting the movable element vibrates at both frequencies of operation with amplitudes that have the same order of magnitude. In this way it is assured that, without an additional control effort, forward and backward motions of the movable element occur that have the same performance characteristics such as force or velocity. In a particularly preferred embodiment, these vibrations have amplitudes of 50 nm-50 μm, preferably, 500 nm-20 μm. In an exceptionally preferred embodiment, the vibrations have amplitudes of 1 μm-5 μm. The particularly advantageous use of the vibrations executed by the resonator is thus made possible.

The drive device 2 disclosed in FIGS. 33a and 33b attempts to specifically use the wear between the resonator 2s and the movable element 5n for optimizing the motor properties and for increasing the motor performance. One advantage of the drive device 2 is that it is able to self blocking the movable element 5n without the need of energy, which allows operating the drive device 2 with little energy.

In a preferred embodiment, the piezoelectric motor also comprises an elastic element 5n for resiliently urging the resonator contact portion 5o against the movable element and for maintaining a predetermined resonator location and/or orientation with respect to the movable element 5n. In a preferred embodiment, the resilience of the elastic element 5n causes that resonator location and/or orientation to change when the resonator contact portion 5o is worn. In a further preferred embodiment, the elastic element also mounts the resonator 2s to a base or rigid body 2u. In a further embodiment no elastic element 5n is used, so that the tip 5o of the resonator 2s directly acts onto the slider 2x, whereby the resonator 2s and the slider 2x may for example be of metal such as aluminum.

In a preferred embodiment, the resonator 2s behavior during running-in and operation, respectively, is preferably measured by way of a measurement of the changing vibration modes, of the frequencies, of the degree of efficiency, etc. In this way, the running-in behavior of the resonator can be determined with simple means. Subsequently, by way of a predetermined change of an operating state variable, preferably by way of adapting the operating frequency to the changed resonance frequency, the mechanical power of the piezoelectric motor can be maintained at least at a constant level.

The contact portion between the movable element 5n and the tip 5o of the resonator 2s is a surface, and preferably a two-dimensional surface when the geometries of the two elements 5n, 50 mutually and preferably exactly conform to each other.

FIGS. 33c and 33d show an example of an embodiment of a deflection apparatus 1. This deflection apparatus 1 is in so fare similar to the deflection apparatus 1 disclosed in FIGS. 26a to 26d, in that three drive devices 2 are used to activate and drive a pivot part 15 with a mirror 4. FIG. 33c shows a top view of the deflection apparatus 1, with the mirror 4 on top and three drive devices 2 arranged below the mirror 4 to pivot the mirror 4 in various directions. FIG. 33d shows a side view of the deflection apparatus 1. The mirror 4 is fixed onto a pivot part 15, and the pivot part 15 is operatively connected through three balls 2z to three respective drive devices 2, which may independently be activated. Each drive device 2 comprising a slider 2x acting onto and moving the respective ball 2z, so that the pivot part 15 can be moved by the respective ball 2z, on three spaced apart locations, in direction B to pivot mirror 4 in various directions. In a preferred embodiment each drive device 2 comprises a spring 2q, similar as shown in FIGS. 26b and 26c, which connects the pivot part 15 with the respective rigid body 2u, to make sure that the pivot part 15 stays in contact with the respective ball 2z and the respective slider 2x.

The deflection apparatus disclosed in FIGS. 33c and 33d can be used particularly advantageously in combination with a pulsed laser in that a laser beam is respectively output with a preferably stationary mirror so that the deflection of the mirror determines the direction of the deflected laser beam and the laser impacts a surface, for example, at a defined position.

The deflection apparatus disclosed in FIGS. 33c and 33d has the advantage that it can be operated at high speed in that it, for example, allows to move the mirror 4 for example about 500 times per second, thus allowing deflecting the laser beam to about 500 different positions of a surface.

The operation of the drive 2 may be as follows:

Starting:

Starting drive 2 may consist of two consecutive phases:
building up an oscillation, for example 3 to 4 motor oscillations
acceleration to the maximum speed

Stopping:

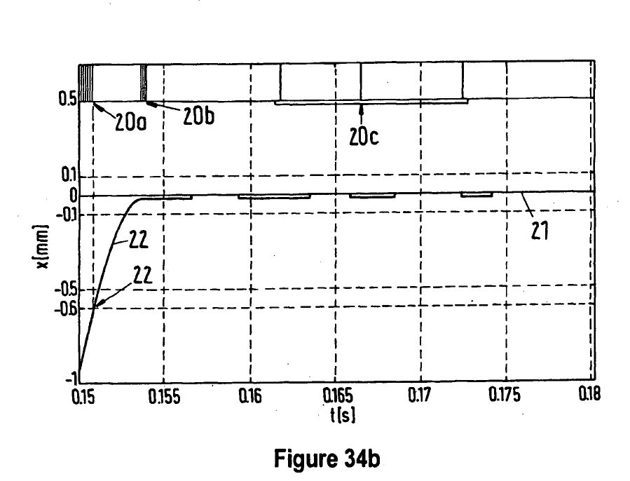

Stopping drive 2 may consist of two or three phases depending on the speed, as disclosed in FIG. 34a. FIG. 34a discloses, inter alia, the movement of the slider 2x versus time.
The oscillation is stopped, as indicated by 20a, and the kinetic energy is transformed into potential energy of the spring 2t
at high speed (>Vcritical), the spring 2t is loaded until the force exceeds the maximum adhesion force then the driven element 2x,5n will start sliding. The braking force is equivalent to the kinetic frictional force.
after the kinetic energy becomes lower than the potential energy of the spring 2t, the slider 2x moves as indicated in curve 22, the moving part 2x,5n starts oscillating. The oscillation will reduce due to the frictional force of the moving part 2x,5n, as disclosed by curve 22, so that the spring 2t stops moving after a period of time 22a. Curve 21 shows the position the slider 2x should reach.

FIG. 34b discloses another stopping procedure. FIG. 34b discloses in curve 22 the movement of the slider 2x versus time, in curve 20a, 20b, 20c the oscillation of the resonator 2s, and in curve 21 the position the slider 2x should reach.
The oscillation of the piezoelectric component 2w is stopped, as indicated by 20a.
   Preferably at the maximum elongation of spring 2t, at position 22b indicated in FIG. 34a, the resonator 2s is activated, as indicated by 20b in FIG. 34b, to move the resonator 2s in such a way the energy stored in spring 2t is decreased, so that the swing of spring 2t is minimized, as can be seen in curve 22 of FIG. 34b.
   To bring the slider 2x in position 21 the slider 2x should reach, further oscillations of the piezoelectric component 2w are applied. In the example shown, the separate oscillations 20c are applied so that the slider 2x reaches the given end position 21.

The advantage of the method disclosed in FIG. 34b is that applying additional oscillations 20b, 20c as the right time allows to more precisely reach with the slider 2x a given end position 21. Such a method allows to more precisely or in a shorter period of time to drive mirror 4 in an end position.

Various other methods of applying additional oscillations 20b, 20c at specific times may be suitable to more precisely and/or in a shorter period of time position the slider 2x and/or the mirror 4.

The drive 2 disclosed in FIGS. 33a to 33b may also be implemented by piezoelectric components 2w of other shapes or for example without a resonator 2s, so that for example only the length of part 2s is varied, for example by using a piezoelectric component, to push or pull slider 2x. The slider 2x might have other shapes, or may have the shape of a plate, on which the part 2s acts to move the plate.

What is claimed is:

1. A deflection apparatus (1) for the deflection of electromagnetic radiation, in particular of a laser beam, including a drive apparatus (2) as well as including a beam deflection apparatus (4), in particular a mirror (4), which is arranged with the drive device (2) such that the drive apparatus (2) determines the alignment of the beam deflection apparatus (4), as well as including a friction apparatus (5) which is arranged and made such that it brings about static friction or sliding friction onto the movably journaled parts moved by the drive device (2), with the drive apparatus (2) being made such that it can generate a drive force which overcomes the static friction, as well as including a control apparatus (10) for the control of the drive apparatus (2).

2. The deflection apparatus (1) in accordance with claim 1, wherein the control apparatus (10) is made such that it generates a starting pulse (12a) of less than 1 ms to move the drive apparatus (2).

3. The deflection apparatus (1) in accordance with claim 1, wherein the control apparatus (10) generates at least one stop pulse (12b) to brake the drive apparatus (2).

4. The deflection apparatus (1) in accordance with claim 3, wherein the control apparatus (10) generates at least 500 starting pulses and stop pulses (12a, 12b) per second.

5. The deflection apparatus (1) in accordance with claim 1, wherein the deflection apparatus further includes a position sensor (11) for the detection of the alignment of the beam deflection apparatus (4) or including a stop (3b) for the defined alignment of the beam deflection apparatus (4).

6. The deflection apparatus (1) in accordance claim 1, wherein the friction apparatus (5) is arranged such that it acts directly onto the drive apparatus (2).

7. The deflection apparatus (1) in accordance with claim 1, wherein the friction apparatus (5) is arranged between the drive apparatus (2) and the beam deflection apparatus (4).

8. The deflection apparatus (1) in accordance with claim 7, wherein the drive apparatus (2) has a stator (2a) and a rotor (2b) rotatably journaled with respect to the stator (2a); wherein the beam deflection apparatus (4) is connected to the rotor (2b) via a connection part (3); and wherein the friction apparatus (5) engages at the connection part (3).

9. The deflection apparatus (1) in accordance with claim 8, wherein the friction apparatus (5) includes two wires (5a, 5b) spaced apart; wherein the connection part (3) includes a cylindrical section (3d); and wherein the wires (5a, 5b) contact the cylindrical section (3d) outwardly at both sides to bring about static friction or sliding friction on the connection part (3) in this manner.

10. The deflection apparatus (1) in accordance with claim 9, wherein the friction apparatus (5) includes a clamping device (5f) which is made such that it permits the pressing force of the wires (5a, 5b) effected onto the connection part (3) to be set.

11. The deflection apparatus (1) in accordance with claim 1, wherein the friction apparatus (5) comprises a moveable linear body (5n) and a front end (5o) of a drive, the front end (5o) when activated, acting in such a way onto the linear body (5n) that the linear body (5n) is moved, whereby the linear body (5n) and the front end (5o) are arranged such, the self blocking occurs between the linear body (5n) and the front end (5o) when the front end (5o) is not actively moved.

12. The deflection apparatus (1) in accordance with claim 2, wherein the drive apparatus (2), after being excited by the starting pulse (12a) at a starting position, reaches a desired end position with an overshoot of less than 1% of the path length between the starting and the end position.

13. A method for the deflection of electromagnetic radiation, in particular of a laser beam, having a rotatably or pivotably journaled beam deflection apparatus (4), in particular a mirror (4), wherein the beam deflection apparatus (4) is driven by a drive apparatus (2), wherein static friction or sliding friction is effected onto the beam deflection apparatus (4) or the drive apparatus (2); wherein the drive apparatus (2) is commanded by of a starting pulse (12a); wherein in particular at least 500 starting pulses (12a) are generated per second; and wherein the static friction and sliding friction, the amplitude of the starting pulses (12a) as well as the time duration between two sequential starting pulses (12a) are mutually matched such that the drive apparatus (2) and also the mirror (4) become stationary between two sequential starting pulses (12a).

14. The method in accordance with claim 13, wherein the staring pulse (12a) is less than 1 ms.

15. The method in accordance with claim 13, wherein the period of the standstill amounts to at least a third of the time duration between two sequential starting pulses (12a).

16. The method in accordance with claim 13, wherein at least one stop pulse (12b) is generated after the starting pulse (12a).

17. The method in accordance with claim 16, wherein a further correction pulse (12c) which acts in driving or braking manner onto the drive apparatus (2) is generated after the starting pulse (12a) and the stop pulse (12b).

18. The method in accordance with claim 16, wherein the pulse width of the starting pulse (12a), of the stop pulse (12b) or of the correction pulse (12c) amounts to less than 500 μs.

19. The method in accordance claim 16, wherein the current peak of the starting pulse (12a), of the stop pulse (12b) or of the correction pulse (12c) amounts to at least tenfold, preferably at least a hundredfold, of the nominal current of the drive apparatus (2).

20. The method in accordance with claim 13, wherein a starting position and an end position are preset for the mirror; and wherein at least the amplitude and/or the time duration of the starting pulses (12a) is set such that a defined number of starting pulses (12a) are required for the movement between the starting position and the end position.

21. The method in accordance with claim 13, wherein a starting position and an end position are preset for the mirror; and wherein at least the repetition rate, the recess time and the pulse form of the starting pulses (12a) is set such that a defined number of starting pulses (12a) are required for the movement between the starting position and the end position.

22. Use of a method in accordance with claim 13 for the operation of a pulsed laser (13), with the activation of the laser beam and the position of the mirror (4) being synchronized such that the laser is activated when the mirror (4) is stationary.

23. Use of a deflection apparatus in accordance with claim 1, for deflecting a beam of a pulsed laser to one of various positions of a target area, especially onto biological tissue, wherein the selected position is targeted at least twice.
